(19) United States
(12) Patent Application Publication
(10) Pub. No.: US 2023/0115368 A1
(43) Pub. Date: Apr. 13, 2023

(54) Improving Random Access Based on Artificial Intelligence / Machine Learning (AI/ML)

(71) Applicant: Telefonaktiebolaget LM Ericsson (publ), Stockholm (SE)

(72) Inventors: Ali Parichehrehteroujeni, Linköping (SE); Marco Belleschi, Solna (SE); Henrik Rydén, Stockholm (SE); Pablo Soldati, Solna (SE)

(21) Appl. No.: 17/919,573

(22) PCT Filed: Apr. 23, 2021
(86) PCT No.: PCT/SE2021/050378

§ 371 Date: Oct. 18, 2022

Related U.S. Application Data
(60) Provisional application No. 63/014,347, filed on Apr. 23, 2020.

(51) Int. Cl. G06N 5/022; H04W 74/08

(52) U.S. Cl. CPC G06N 5/022; H04W 74/0833

(57) ABSTRACT

Embodiments include methods for a network node to configure random access by one or more user equipment, UEs, in a cell of the wireless network. Such methods include providing (2040) one of the following to one or more UEs operating in the cell: an artificial intelligence/machine learning, AI/ML, predictive model that includes one or more input parameters and corresponding one or more output parameters that are associated with random-access configurations for the cell; or one or more random-access configurations for the cell, each random-access configuration associated with one or more values of output parameters of the AI/ML predictive model. Such methods include detecting (2090) a random access to the cell, by a particular UE, according to a particular random-access configuration associated with particular values of the output parameters. Other embodiments include complementary methods for a UE, as well as network nodes and UEs configured to perform such methods.

### TECHNICAL FIELD

Embodiments of the present disclosure generally relate to wireless networks, and particularly relate to improving the ability of wireless devices to perform random access (RA) procedures to wireless networks.

### BACKGROUND

Currently the fifth generation (“5G”) of cellular systems, also referred to as New Radio (NR), is being standardized within the Third-Generation Partnership Project (3GPP). NR is developed for maximum flexibility to support a variety of different use cases. These include enhanced mobile broadband (eMBB), machine type communications (MTC), ultra-reliable low latency communications (URLLC), side-link device-to-device (D2D), and several other use cases. While the present disclosure relates primarily to 5G/NR, the following description of fourth-generation Long-Term Evolution (LTE) technology is provided to introduce various terms, concepts, architectures, etc. that are also used in 5G/NR.

LTE is an umbrella term that refers to radio access technologies developed within the Third-Generation Partnership Project (3GPP) and initially standardized in Release 8 (Rel-8) and Release 9 (Rel-9), also known as Evolved UTRAN (E-UTRAN). LTE is targeted at various licensed frequency bands and is accompanied by improvements to non-radio aspects commonly referred to as System Architecture Evolution (SAE), which includes Evolved Packet Core (EPC) network. LTE continues to evolve through subsequent releases.

An overall exemplary architecture of a network comprising LTE and SAE is shown in FIG. 1. E-UTRAN 100 includes one or more evolved Node B's (eNB), such as eNBs 105, 110, and 115, and one or more user equipment (UE), such as UE 120. As used within the 3GPP standards, “user equipment” or “UE” means any wireless communication device (e.g., smartphone or computing device) that is capable of communicating with 3GPP-standard-compliant network equipment, including E-UTRAN as well as UTRAN and/or GERAN, as the third-generation (“3G”) and second-generation (“2G”) 3GPP RANs are commonly known.

As specified by 3GPP, E-UTRAN 100 is responsible for all radio-related functions in the network, including radio bearer control, radio admission control, radio mobility control, scheduling, and dynamic allocation of resources to UEs in uplink and downlink, as well as security of the communications with the UE. These functions reside in the eNBs, such as eNBs 105, 110, and 115. Each of the eNBs can serve a geographic coverage area including one more cells, including cells 106, 111, and 115 served by eNBs 105, 110, and 115, respectively.

The eNBs in the E-UTRAN communicate with each other via the X2 interface, as shown in FIG. 1. The eNBs also are responsible for the E-UTRAN interface to the EPC 130, specifically the S1 interface to the Mobility Management Entity (MME) and the Serving Gateway (SGW), shown collectively as MME/S-GWs 134 and 138 in FIG. 1. In general, the MME/S-GW handles both the overall control of the UE and data flow between the UE and the rest of the EPC. More specifically, the MME processes the signaling (e.g., control plane) protocols between the UE and the EPC, which are known as the Non-Access Stratum (NAS) protocols. The S-GW handles all Internet Protocol (IP) data packets (e.g., data or user plane) between the UE and the EPC and serves as the local mobility anchor for the data bearers when the UE moves between eNBs, such as eNBs 105, 110, and 115.

EPC 130 can also include a Home Subscriber Server (HSS) 131, which manages user- and subscriber-related information. HSS 131 can also provide support functions in mobility management, call and session setup, user authentication and access authorization. The functions of HSS 131 can be related to the functions of legacy Home Location Register (HLR) and Authentication Centre (AuC) functions or operations. HSS 131 can also communicate with MMEs 134 and 138 via respective S6a interfaces.

In some embodiments, HSS 131 can communicate with a user data repository (UDR)—labelled EPC-UDR 135 in FIG. 1—via a Ud interface. EPC-UDR 135 can store user credentials after they have been encrypted by AuC algorithms. These algorithms are not standardized (i.e., vendor-specific), such that encrypted credentials stored in EPC-UDR 135 are inaccessible by any other vendor than the vendor of HSS 131.

FIG. 2 illustrates a block diagram of an exemplary control plane (CP) protocol stack between a UE, an eNB, and an MME. The exemplary protocol stack includes Physical (PHY), Medium Access Control (MAC), Radio Link Control (RLC), Packet Data Convergence Protocol (PDCP), and Radio Resource Control (RRC) layers between the UE and eNB. The PHY layer is concerned with how and what characteristics are used to transfer data over transport channels on the LTE radio interface. The MAC layer provides data transfer services on logical channels, maps logical channels to PHY transport channels, and reallocates PHY resources to support these services. The RLC layer provides error detection and/or correction, concatenation, segmentation, and reassembly, reordering of data transferred to or from the upper layers. The PDCP layer provides ciphering/deciphering and integrity protection for both CP and user plane (UP), as well as other UP functions such as header compression. The exemplary protocol stack also includes non-access stratum (NAS) signaling between the UE and the MME.

The RRC layer controls communications between a UE and an eNB at the radio interface, as well as the mobility of a UE between cells in the E-UTRAN. After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE does not belong to any cell, no RRC context has been established for the UE (e.g., in E-UTRAN), and the UE is out of UL synchronization with the network. Even so, a UE in RRC_IDLE state is known in the EPC and has an assigned IP address.

Furthermore, in RRC_IDLE state, the UE's radio is active on a discontinuous reception (DRX) schedule configured by upper layers. During DRX active periods (also referred to as “On durations”), an RRC_IDLE UE receives system information (SI) broadcast by a serving cell, performs measurements of neighbor cells to support cell reselection, and monitors a paging channel for pages from the EPC via an eNB serving the cell in which the UE is camping.

A UE must perform a random-access (RA) procedure to move from RRC_IDLE to RRC_CONNECTED state. In RRC_CONNECTED state, the cell serving the UE is known and an RRC context is established for the UE in the serving eNB, such that the UE and eNB can communicate. For example, a Cell Radio Network Temporary Identifier (C-RNTI)—a UE identity used for signaling between UE and network—is configured for a UE in RRC_CONNECTED state.

Logical channel communications between a UE and an eNB are via radio bearers. Signaling radio bearers (SRBs) SRB0, SRB1, and SRB2 are used for transport of RRC and NAS messages. For example, SRB0 is used for RRC connection setup, RRC connection resume, and RRC connection re-establishment. Once any of these operations has succeeded, SRB1 is used for handling RRC messages (including piggybacked NAS messages) and for NAS messages prior to SRB2 establishment. SRB2 is used for NAS messages and lower-priority RRC messages (e.g., logged measurement information). SRB0 and SRB1 are also used to establish and modify data radio bearers (DRBs) that carry user data between UE and eNB.

The fifth generation (“5G”) of cellular systems, also referred to as New Radio (NR), is being standardized within the Third-Generation Partnership Project (3GPP). NR is developed for maximum flexibility to support a variety of different use cases. These include enhanced mobile broadband (eMBB), machine type communications (MTC), ultra-reliable low latency communications (URLLC), and several other use cases.

Fifth-generation NR technology shares many similarities with fourth-generation LTE. For example, NR uses CP-OFDM (Cyclic Prefix Orthogonal Frequency Division Multiplexing) in the DL and both CP-OFDM and DFT-spread OFDM (DFT-S-OFDM) in the UL. In the time domain, NR DL and UL physical resources are organized into equal-sized 1-ms subframes, each subframe being divided into multiple slots of equal duration and each slot including multiple OFDM-based symbols. NR RRC layer includes RRC_IDLE and RRC_CONNECTED states but adds another RRC_INACTIVE state with properties similar to a “suspended” condition in LTE.

In addition to providing coverage via cells, as in LTE, NR networks also provide coverage via “beams.” In general, a DL “beam” is a coverage area of a network-transmitted RS that may be measured or monitored by a UE. In NR, for example, such RS can include any of the following, alone or in combination: SS/PBCH block (SSB), CSI-RS, tertiary RS (or any other sync signal), positioning RS (PRS), DM-RS, phase-tracking reference signals (PTRS), etc. In general, SSB is available to all UEs regardless of RRC state, while other RS (e.g., CSI-RS, DM-RS, PTRS) are associated with specific UEs that have a network connection, i.e., in RRC_CONNECTED state.

For both LTE and NR, a UE can perform a random-access (RA) procedure in any of the following scenarios, events, and/or conditions:
Initial access from RRC_IDLE state;
During an RRC connection re-establishment procedure;
During handover (i.e., change in serving cell while in RRC_CONNECTED state);
Upon arrival of DL data while in RRC_CONNECTED state (as needed); and
Upon arrival of UL data while in RRC_CONNECTED state (as needed, e.g., when the UE's UL is non-synchronized with the network and/or there are no PUCCH resources available for transmitting a scheduling request, SR).

Conventionally, UEs perform contention-based random-access (CBRA) in which initial transmissions (also referred to as “preambles,” “sequences,” or “msg1”) via a random access channel (RACH) can collide with initial transmissions from other UEs attempting to access the same cell via the same RACH. Note that RACH is an UL transport layer channel that is based on PRACH of the PHY, discussed above. When such collisions occur, the network may not correctly receive a UE's random-access preamble transmissions, causing the UE to attempt retransmission at a higher power level, referred to as “power ramping”.

One way the network can control interference among UE RA procedures is by configuring UEs with a target power level for preambles at the network receiver. This parameter (called preambleReceivedTargetPower in LTE) can be configured via RRC. Conventionally, the same preambleReceivedTargetPower is used for all the UEs operating in a cell's coverage are, regardless of UE distance from the network's receiving antenna for the cell (e.g., associated with a base station serving the cell). As such, UEs often must perform trial and error to find an optimal RACH power level (e.g., via power ramping), which can introduce random-access delay, undesired and/or necessary UE energy consumption, and additional interference on the RACH.

### SUMMARY

Embodiments of the present disclosure provide specific improvements to communication between user equipment (UE) and network nodes in a wireless communication network, such as by facilitating solutions to overcome the exemplary problems summarized above and described in more detail below.

Some embodiments include methods (e.g., procedures) for a network node to configure random access by one or more UEs in a cell of the wireless network. These exemplary methods can be performed by a network node (e.g., base station, eNB, gNB, en-gNB, etc., or component thereof) serving the cell in the wireless network (e.g., E-UTRAN, NG-RAN).

These exemplary methods can include providing one of the following to one or more UEs operating in the cell:
an AI/ML predictive model that includes one or more input parameters and corresponding one or more output parameters that are associated with random-access configurations for the cell; or
one or more random-access configurations for the cell, each random-access configuration associated with one or more values of output parameters of the AI/ML predictive model.

These exemplary methods can also include detecting a random access to the cell, by a particular UE, according to a particular random-access configuration associated with particular values of the output parameters.

In some embodiments, these exemplary methods can also include collecting a training dataset with a plurality of entries. Each training dataset entry can include input parameter values and corresponding output parameter values. In some of these embodiments, the training dataset can include one or more of the following:
measurements of DL signals made by UEs operating in the cell;
measurements of UL signals transmitted by UEs operating in the cell;
measurements from one or more network nodes serving neighbor cells;
random access reports by UEs operating in the cell;
connection establishment failure reports by UEs operating in the cell;
location information for UEs operating in the cell; and
timing advance for UEs operating in the cell.

In some of these embodiments, the respective training dataset entries can include one or more of the following input parameter values:
one or more measurements made by a UE on neighboring cells or frequencies,
one or more beam measurements made by a UE in the cell, and
   In addition, the respect training dataset entries can include one or more of the following corresponding output parameter values:
an indication of failed or successful random access to the cell, and
an indication of failed or successful connection establishment.

In some embodiments, the provided AI/ML predictive model can be untrained, and these exemplary methods can also include sending at least a first portion of the training dataset to the one or more UEs.

In other embodiments, these exemplary methods can also include training the AI/ML predictive model based on at least a first portion of the training dataset. In such embodiments, the trained AI/ML predictive model is provided to the one or more UEs.

In some embodiments, these exemplary methods can also include receiving one or more of the following from a particular UE operating in the cell: an indication that the provided AI/ML predictive model needs to be retrained, and a request for a further training dataset for retraining the model. In such embodiments, these exemplary methods can also include either sending a second portion of the training dataset to the particular UE or retraining the AI/ML predictive model based a second portion of the training dataset and sending the retrained AI/ML predictive model to the particular UE.

In other embodiments, these exemplary methods can also include obtaining the one or more random-access configurations for the cell based on the trained AI/ML predictive model. In such embodiments, the obtained random-access configurations are provided to the one or more UEs via broadcast in the cell.

In some embodiments, these exemplary methods can also include selecting the AI/ML predictive model from a plurality of available model types based on one or more of the following criteria: wireless network capabilities, UE capabilities, model size and/or complexity, severity of random access problems in the cell, available inputs, necessary and/or desirable outputs, need for retraining the model.

In some embodiments, the input parameters to the AI/ML predictive model can include any of the following:
cell- and beam-level link quality of the cell;
cell- and beam-level link quality of the one or more neighbor cells;
relations between beams of the cell and the neighbor cells;
UE timing advance;
UE location;
UE precoding matrix indicator (PMI);
strength or quality of uplink (UL) reference signals received from UEs;
random access collisions reported by UEs; and
one or more of the following UE-related information: model, class, type, manufacturer, receiver type, and number of antennas.

In some embodiments, the output parameters to the AI/ML predictive model can include any of the following:
one or more power levels for an initial transmission of a random-access preamble,
one or more measurement thresholds corresponding to the power levels,
one or more power ramping steps for retransmissions of the random-access preamble,
maximum number of preamble retransmissions before declaring random access failure, and
set of downlink (DL) beams to be used for random access.

In some embodiments, the AI/ML predictive model can include, for each beam of one of more DL beams of the cell, one or more relations between a measurement range of a reference signal of the beam and a corresponding power level for an initial transmission of a random-access preamble.

Other embodiments include methods (e.g., procedures) for a UE to perform random access in a cell of a wireless network. These exemplary methods can be performed by a UE (e.g., wireless device, IoT device, etc., or component thereof).

These exemplary methods can include receiving one of the following from a network node serving the cell:
an AI/ML predictive model that includes one or more input parameters and corresponding one or more output parameters that are associated with random-access configurations for the cell; or
one or more random-access configurations for the cell, each random-access configuration associated with one or more values of output parameters of the AI/ML predictive model.

These exemplary methods can also include performing a random access to the cell according to a particular random-access configuration associated with particular values of the output parameters.

In some embodiments, the one or more random-access configurations are obtained via broadcast in the cell. In other embodiments, the obtained AI/ML predictive model has been trained by the network node.

In other embodiments, the obtained AI/ML predictive model is untrained. In such embodiments, these exemplary methods can also include training the obtained AI/ML predictive model based on a training dataset with a plurality of entries, with each training dataset entry including input parameter values and corresponding output parameter values. In some of these embodiments, these exemplary methods can also include receiving at least a portion of the training dataset from the network node, including one more of the following:
measurements of downlink (DL) signals made by UEs operating in the cell;
measurements of uplink (UL) signals transmitted by UEs operating in the cell;
measurements from one or more network nodes serving neighbor cells;
random access reports by UEs operating in the cell;
connection establishment failure reports by UEs operating in the cell;
location information for UEs operating in the cell; and
timing advance for UEs operating in the cell.

In some of these embodiments, each of the training dataset entries received from the network node can include one or more of the following input parameter values:
one or more measurements made by a UE on neighboring cells or frequencies,
one or more beam measurements made by a UE in the cell, and
   In addition, each of the training dataset entries can include one or more of the following corresponding output parameter values:
an indication of failed or successful random access to the cell, and
an indication of failed or successful connection establishment.

In some embodiments, these exemplary method scan also include collecting one or more of the following included in the training dataset:
UE measurements of DL signals in the wireless network;
information about the UE's random access attempts in the cell;
information about the UE's connection establishment attempts in the cell;
UE location information; and
UE timing advance.
   For example, the collecting operations can be performed during the UE's operations in or proximate to the cell.

In some embodiments, performing the random access can include various sub-operations such as: determining respective values for the input parameters; applying the AI/ML predictive model to the values of the input parameters to determine respective values of the output parameters; and selecting the particular random-access configuration according to the determined values of the output parameters.

In some embodiments, these exemplary methods can also include, based on the random access being unsuccessful, determining that the AI/ML predictive model needs to be retrained and sending one or more of the following to the network node: an indication that the obtained AI/ML predictive model needs to be retrained, and a request for a further training dataset for retraining the model. Additionally, these embodiments can also include one of the following operations: receiving a further training dataset from the network node and retraining the AI/ML predictive model based on the further training dataset and one or more measurements made by the UE; or receiving the retrained AI/ML predictive model from the network node.

In various embodiments, the input parameters and the output parameters for the AI/ML predictive model can be any of those summarized above for the network node embodiments.

Other embodiments include user equipment (UEs, e.g., wireless devices, IoT devices, or components thereof, such as a modem) or network nodes (e.g., base stations, eNBs, gNBs, en-gNBs, etc., or components thereof) configured to perform operations corresponding to the exemplary methods described herein. Other embodiments include non-transitory, computer-readable media storing program instructions that, when executed by processing circuitry, configure such UEs or network nodes to perform operations corresponding to the exemplary methods described herein.

Embodiments described herein can assist and/or facilitate a UE or a network node to choose random access parameters more accurately according to the UE's current situation in a serving cell. As such, embodiments can facilitate UE success on first attempt of a RACH procedure and thereby reduce random access delay, which can be particularly important for delay sensitive services. By facilitating UE success with a minimal and/or reduced number (e.g., one) of random access attempts, such techniques can reduce both UL interference among neighboring cells operating at the same frequency and UE energy consumption for random access.

These and other objects, features, and advantages of embodiments of the present disclosure will become apparent upon reading the following Detailed Description in view of the Drawings briefly described below.

### BRIEF DESCRIPTION OF THE DRAWINGS

FIG. 1 is a high-level block diagram of an exemplary architecture of the Long-Term Evolution (LTE) Evolved UTRAN (E-UTRAN) and Evolved Packet Core (EPC) network.

FIG. 2 is a block diagram of exemplary protocol layers of the control-plane (CP) portion of the radio (Uu) interface between a user equipment (UE) and the E-UTRAN.

FIGS. 3-4 illustrate two high-level views of an exemplary 5G network architecture.

FIG. 5 shows an exemplary frequency-domain configuration for a 5G/NR UE.

FIG. 6 shows an exemplary time-frequency resource grid for an NR (e.g., 5G) slot.

FIGS. 7A-7B show exemplary NR slot and mini-slot configurations.

FIG. 8 illustrates an exemplary contention-based random access (CBRA) procedure.

FIG. 9 shows an exemplary time- and frequency-multiplexing of PRACH, PUCCH, and PUCCH physical channels.

FIG. 10 shows contents of an exemplary random-access response (RAR) message.

FIG. 11 illustrates a scenario where two UEs attempt to access a cell using the same RA preamble.

FIGS. 12A-B show exemplary ASN.1 data structures for RACH-ConfigCommon and RACH-ConfigGeneric IEs, respectively.

FIG. 13 illustrates an exemplary arrangement where a cell includes various downlink beams associated with respective SSB indices.

FIGS. 14A-B show two exemplary configurations for SS/PCBH blocks (SSBs) per RACH occasion.

FIG. 15 illustrates an exemplary scenario where a UE transmits random access preambles corresponding to two different SSB indices.

FIG. 16 shows an exemplary ASN.1 data structure for a MobilityControlInfo IE.

FIG. 17 shows an exemplary ASN.1 data structure for a RACH-ConfigDedicated IE.

FIGS. 18A-C illustrate various aspects of an LTE UE Information procedure.

FIG. 19 shows an exemplary linear regression model in which initial transmission power level is an output based on inputs of UE measurements (e.g., RSRP) on two beams.

FIG. 20 shows a flow diagram of an exemplary method (e.g., procedure) for network node of a wireless network, according to various exemplary embodiments of the present disclosure.

FIG. 21 shows a flow diagram of an exemplary method (e.g., procedure) for a UE, according to various exemplary embodiments of the present disclosure.

FIG. 22 is a block diagram of an exemplary wireless device or UE according to various exemplary embodiments of the present disclosure.

FIG. 23 is a block diagram of an exemplary network node according to various exemplary embodiments of the present disclosure.

FIG. 24 is a block diagram of an exemplary network configured to provide over-the-top (OTT) data services between a host computer and a UE, according to various exemplary embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are given by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB) in a 3GPP Fifth Generation (5G) NR network or an enhanced or evolved Node B (eNB) in a 3GPP LTE network), base station distributed components (e.g., CU and DU), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, aerial devices or drones, ProSe UEs, V2V UEs, V2X UEs, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Node: As used herein, a “node” can be a network node or a user equipment (UE), according to the above definitions of those terms.

Note that the description herein focuses on a 3GPP cellular communications system and, as such, 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

As briefly mentioned above, UEs often must perform trial and error to find an optimal power level (e.g., via power ramping) for preamble transmission on RACH, which can introduce random-access delay, undesired and/or necessary UE energy consumption, and additional interference on RACH. This is discussed in more detail after the following description of NR network architectures and radio interface.

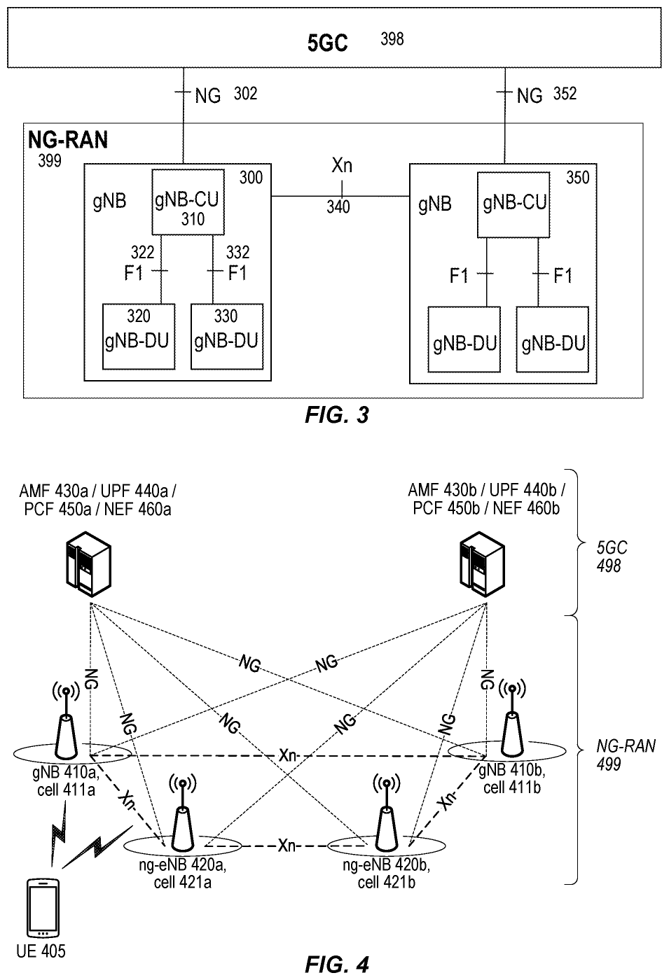

FIG. 3 illustrates a high-level view of the 5G network architecture, consisting of a Next Generation RAN (NG-RAN) 399 and a 5G Core (5GC) 398. NG-RAN 399 can include a set of gNodeB's (gNBs) connected to the 5GC via one or more NG interfaces, such as gNBs 300, 350 connected via interfaces 302, 352, respectively. In addition, the gNBs can be connected to each other via one or more Xn interfaces, such as Xn interface 340 between gNBs 300 and 350. With respect the NR interface to UEs, each of the gNBs can support frequency division duplexing (FDD), time division duplexing (TDD), or a combination thereof.

NG-RAN 399 is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport. In some exemplary configurations, each gNB is connected to all 5GC nodes within an “AMF Region,” which is defined in 3GPP TS 23.501. If security protection for CP and UP data on TNL of NG-RAN interfaces is supported, NDS/IP shall be applied.

The NG RAN logical nodes shown in FIG. 3 include a central (or centralized) unit (CU or gNB-CU) and one or more distributed (or decentralized) units (DU or gNB-DU). For example, gNB 300 includes gNB-CU 310 and gNB-DUs 320 and 340. CUs (e.g., gNB-CU 310) are logical nodes that host higher-layer protocols and perform various gNB functions such controlling the operation of DUs. Each DU is a logical node that hosts lower-layer protocols and can include, depending on the functional split, various subsets of the gNB functions. As such, each of the CUs and DUs can include various circuitry needed to perform their respective functions, including processing circuitry, transceiver circuitry (e.g., for communication), and power supply circuitry. Moreover, the terms “central unit” and “centralized unit” are used interchangeably herein, as are the terms “distributed unit” and “decentralized unit.”

A gNB-CU connects to gNB-DUs over respective F1 logical interfaces, such as interfaces 322 and 332 shown in FIG. 3. The gNB-CU and connected gNB-DUs are only visible to other gNBs and the 5GC as a gNB. In other words, the F1 interface is not visible beyond gNB-CU.

FIG. 4 shows a high-level view of an exemplary 5G network architecture, including a Next Generation Radio Access Network (NG-RAN) 499 and a 5G Core (5GC) 498. As shown in the figure, NG-RAN 499 can include gNBs 410 (e.g., 410a,b) and ng-eNBs 420 (e.g., 420a,b) that are interconnected with each other via respective Xn interfaces. The gNBs and ng-eNBs are also connected via the NG interfaces to 5GC 498, more specifically to the AMF (Access and Mobility Management Function) 430 (e.g., AMFs 430a,b) via respective NG-C interfaces and to the UPF (User Plane Function) 440 (e.g., UPFs 440a,b) via respective NG-U interfaces. Moreover, the AMFs 430a,b can communicate with one or more policy control functions (PCFs, e.g., PCFs 450a,b) and network exposure functions (NEFs, e.g., NEFs 460a,b).

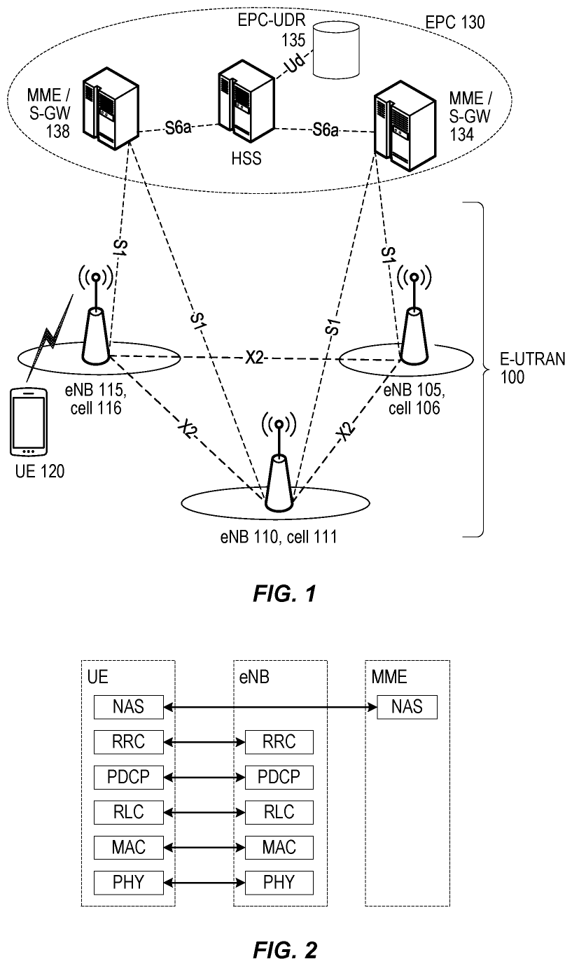

Each of the gNBs 410 can support the NR radio interface including frequency division duplexing (FDD), time division duplexing (TDD), or a combination thereof. In contrast, each of ng-eNBs 420 can support the LTE radio interface but, unlike conventional LTE eNBs (such as shown in FIG. 1), connect to the 5GC via the NG interface. Each of the gNBs and ng-eNBs can serve a geographic coverage area including one more cells, including cells 411a-b and 421a-b shown as exemplary in FIG. 4. As mentioned above, the gNBs and ng-eNBs can also use various directional beams to provide coverage in the respective cells. Depending on the particular cell in which it is located, a UE 405 can communicate with the gNB or ng-eNB serving that particular cell via the NR or LTE radio interface, respectively.

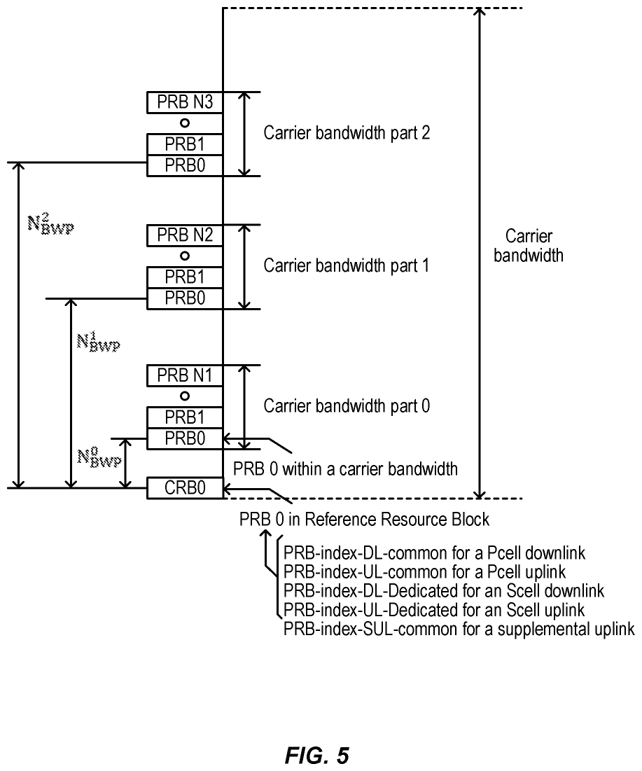

FIG. 5 shows an exemplary frequency-domain configuration for an NR UE. In Rel-15 NR, a UE can be configured with up to four carrier bandwidth parts (BWPs) in the DL with a single DL BWP being active at a given time. A UE can be configured with up to four BWPs in the UL with a single UL BWP being active at a given time. If a UE is configured with a supplementary UL, the UE can be configured with up to four additional BWPs in the supplementary UL, with a single supplementary UL BWP being active at a given time.

Common RBs (CRBs) are numbered from 0 to the end of the carrier bandwidth. Each BWP configured for a UE has a common reference of CRBO, such that a configured BWP may start at a CRB greater than zero. CRBO can be identified by one of the following parameters provided by the network, as further defined in 3GPP TS 38.211 section 4.4:
PRB-index-DL-common for DL in a primary cell (PCell, e.g., PCell or PSCell);
PRB-index-UL-common for UL in a PCell;
PRB-index-DL-Dedicated for DL in a secondary cell (SCell);
PRB-index-UL-Dedicated for UL in an SCell; and
PRB-index-SUL-common for a supplementary UL.

In this manner, a UE can be configured with a narrow BWP (e.g., 10 MHz) and a wide BWP (e.g., 100 MHz), each starting at a particular CRB, but only one BWP can be active for the UE at a given point in time. Within a BWP, PRBs are defined and numbered in the frequency domain from 0 to N_{BWPi}^{size}−1, where i is the index of the particular BWP for the carrier.

Each NR resource element (RE) corresponds to one OFDM subcarrier during one OFDM symbol interval. NR supports various SCS values Δf=(15×2^{μ}) kHz, where μ∈(0,1,2,3,4) are referred to as “numerologies.” Numerology μ=0 (i.e., Δf=15 kHz) provides the basic (or reference) SCS that is also used in LTE. The symbol duration, cyclic prefix (CP) duration, and slot duration are inversely related to SCS or numerology. For example, there is one (1-ms) slot per subframe for Δf=15 kHz, two 0.5-ms slots per subframe for Δf=30 kHz, etc. In addition, the maximum carrier bandwidth is directly related to numerology according to 2^{μ}*50 MHz.

Table 1 below summarizes the supported NR numerologies and associated parameters. Different DL and UL numerologies can be configured by the network.

TABLE 1

| | | Cyclic | | | | | | | | Max | |
|---|---|---|---|---|---|---|---|---|---|---|---|
| | Δf = 2^{μ} · | prefix | CP | Symbol | | Symbol + | | Slot | | carrier | |
| μ | 15 (kHz) | (CP) | duration | duration | | CP | | duration | | BW | |
| 0 | 15 | Normal | 4.69 μs | 66.67 | μs | 71.35 | μs | 1 | ms | 50 | MHz |
| 1 | 30 | Normal | 2.34 μs | 33.33 | μs | 35.68 | μs | 0.5 | ms | 100 | MHz |
| 2 | 60 | Normal, | 1.17 μs | 16.67 | μs | 17.84 | μs | 0.25 | ms | 200 | MHz |
| | | Extended | | | | | | | | | |
| 3 | 120 | Normal | 0.59 μs | 8.33 | μs | 8.92 | μs | 125 | μs | 400 | MHz |
| 4 | 240 | Normal | 0.29 μs | 4.17 | μs | 4.46 | μs | 62.5 | μs | 800 | MHz |

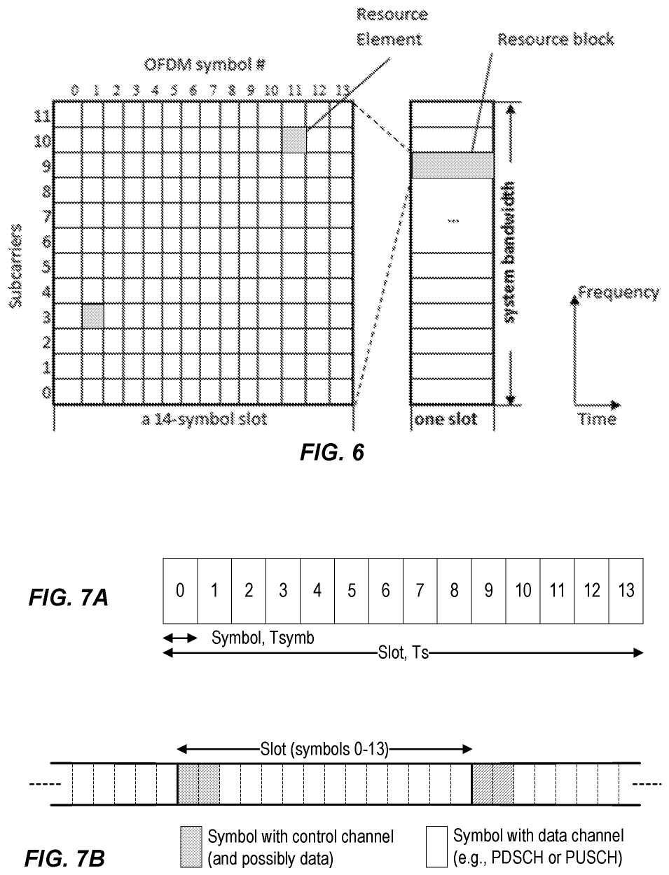

FIG. 6 shows an exemplary time-frequency resource grid for an NR slot. As illustrated in FIG. 6, a resource block (RB) consists of a group of 12 contiguous OFDM subcarriers for a duration of a 14-symbol slot. Like in LTE, a resource element (RE) consists of one subcarrier in one slot. An NR slot can include 14 OFDM symbols for normal cyclic prefix and 12 symbols for extended cyclic prefix.

FIG. 7A shows an exemplary NR slot configuration comprising 14 symbols, where the slot and symbols durations are denoted Tₛ and T_{symb}, respectively. In addition, NR includes a Type-B scheduling, also known as “mini-slots.” These are shorter than slots, typically ranging from one symbol up to one less than the number of symbols in a slot (e.g., 13 or 11), and can start at any symbol of a slot. Mini-slots can be used if the transmission duration of a slot is too long and/or the occurrence of the next slot start (slot alignment) is too late. Applications of mini-slots include unlicensed spectrum and latency-critical transmission (e.g., URLLC). However, mini-slots are not service-specific and can also be used for eMBB or other services.

In general, NR physical channels corresponds to a set of REs carrying information that originates from higher layers. DL physical channels include Physical Downlink Shared Channel (PDSCH), Physical Downlink Control Channel (PDCCH), and Physical Broadcast Channel (PBCH), among others. PDSCH is used for unicast DL data transmission and also carries random access responses, certain system information blocks (SIBs), and paging information. PBCH carries basic system information required by the UE to access the network. PDCCH is used to transmit DL control information (DCI) including scheduling information for DL messages on PDSCH, grants for UL transmission on PUSCH, and channel quality feedback (e.g., CSI) for the UL channel.

UL physical channels Physical Uplink Shared Channel (PUSCH), Physical Uplink Control Channel (PUCCH), and Physical Random Access Channel (PRACH). PUSCH is the UL counterpart to the PDSCH, used by UEs to transmit UL control information (UCI) including HARQ feedback for DL transmissions, channel quality feedback (e.g., CSI) for the DL channel, scheduling requests (SRs), etc. PRACH is used for random access preamble transmission.

As mentioned above, the NR PHY includes various reference signals (RS) such as synchronization signal/PBCH block (SSB), channel state information RS (CSI-RS), tertiary RS, positioning RS (PRS), demodulation reference signals (DM-RS), phase-tracking RS (PTRS), etc. In general, SSB is available to all UEs regardless of RRC state, while other RS (e.g., CSI-RS, DM-RS, PTRS) are associated with specific UEs that have a network connection, i.e., in RRC_CONNECTED state.

FIG. 7B shows another exemplary NR slot structure comprising 14 symbols. In this arrangement, PDCCH is confined to a region containing a particular number of symbols and a particular number of subcarriers, referred to as the control resource set (CORESET). In the exemplary structure shown in FIG. 7B, the first two symbols contain PDCCH and each of the remaining 12 symbols contains physical data channels (PDCH), i.e., either PDSCH or PUSCH. Depending on the particular CORESET configuration, however, the first two slots can also carry PDSCH or other information, as required.

Similar to LTE, NR data scheduling is done on a per-slot basis. In each slot, the base station (e.g., gNB) transmits downlink control information (DCI) over PDCCH that indicates which UE is scheduled to receive data in that slot, as well as which RBs will carry that data. A UE first detects and decodes DCI and, if the DCI includes DL scheduling information for the UE, receives the corresponding PDSCH based on the DL scheduling information. DCI formats 1_0 and 1_1 are used to convey PDSCH scheduling.

Likewise, DCI on PDCCH can include UL grants that indicate which UE is scheduled to transmit data on PUCCH in that slot, as well as which RBs will carry that data. A UE first detects and decodes DCI and, if the DCI includes an uplink grant for the UE, transmits the corresponding PUSCH on the resources indicated by the UL grant. DCI formats 0_0 and 0_1 are used to convey UL grants for PUSCH, while other DCI formats (2_0, 2_1, 2_2 and 2_3) are used for other purposes including transmission of slot format information, reserved resource, transmit power control information, etc.

In addition to dynamic scheduling on a per-slot basis, discussed above, NR also supports semi-persistent scheduling in the DL. In this approach, the network configures a periodicity of PDSCH transmission via RRC and then controls the start and stop of transmissions via DCI in PDCCH. One advantage of this technique is reduction of control signaling overhead on PDCCH. NR also supports a similar feature on the UL, referred to as configured grants (CG).

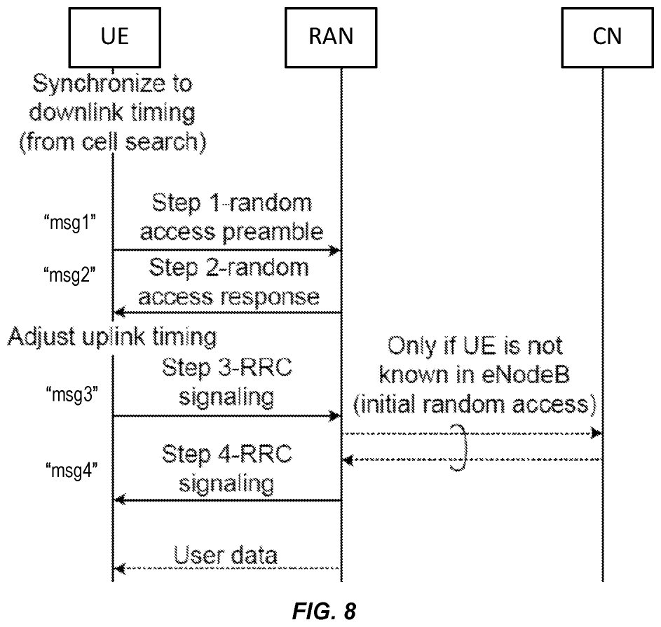

UEs conventionally access a serving cell using a contention-based random-access procedure (CBRA). FIG. 8 illustrates the steps (i.e., operations) in an exemplary CBRA procedure. In step 1, the UE randomly selects one random-access preamble (or sequence) from a known set of preambles indicated by the network (i.e., the serving RAN node, such as eNB or gNB) via broadcast system information (SI, e.g., SIB2). The purpose of random preamble selection is to avoid collisions by separating the preambles in a code domain.

Even so, random preamble selection may result in more than one UE simultaneously transmitting the same preamble, leading to a need for a subsequent contention resolution process. For some use cases of random access (e.g., handovers), the RAN (e.g., eNB or gNB) has the option of preventing contention by allocating a dedicated preamble to a UE, resulting in contention-free random access (CBRA). This is faster than CFRA, which can be particularly important for handover, which is time-critical, even though it requires the network to reserve resources, which may be inefficient. In LTE, a fixed number of 64 preambles is available in each LTE cell, which must be partitioned between CBRA and CFRA usage. In LTE, the UE may obtain RACH configuration in SIB2, in the RRC information element (IE) RadioResourceConfigCommonSIB when it transitions from RRC_IDLE to RRC_CONNECTED, or in the RadioResourceConfigCommon IE when it is handed over to another cell.

The UE randomly selects one of the preambles available for CBRA, which is 64 minus the number of preambles reserved for CFRA. This value is provided by the field numberOfRA-Preambles in the RACH-ConfigCommon IE. The available CBRA preambles are further divided into two groups. The grouping allows the UE to signal with one bit whether it needs radio resources for a small or large message (data package). That is, a randomly selected preamble from one group can indicate that the UE has a small amount of data to send, while a preamble selected from another group indicates that resources for a larger amount of data are needed.

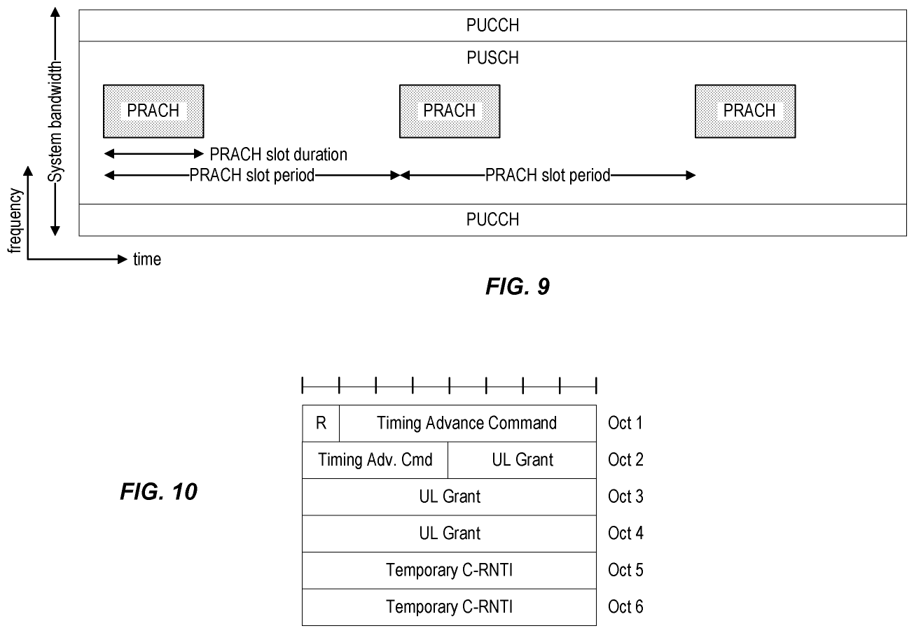

The UE transmits the selected RA preamble (also referred to as “msg1”) only on certain UL time/frequency resources, which are also made known to all UEs via the broadcast SI. From a L1/PHY perspective, the preamble is transmitted in PRACH, which is time- and frequency-multiplexed with PUSCH and PUCCH as shown in FIG. 9. PRACH time-frequency resources are semi-statically allocated within the PUSCH region and repeat periodically, shown in FIG. 9.

At the network side, these resources are monitored by the eNB serving the cell to detect any RACH attempts by UEs in the cell. The eNB detects all non-colliding preambles transmitted by UEs in these resources and estimates the roundtrip time (RTT) for each UE. The RTT is needed to achieve time and frequency synchronization in both DL and UL for the UE in the LTE or NR OFDM-based systems.

In Step 2, the RA response (RAR, also referred to as “msg2”) from the RAN (e.g., eNB or gNB) carries the RTT (in the form of a “timing advance command”), a temporary UE identity (e.g., C-RNTI), and UL grant of resources for the UE to use in step 3. FIG. 10 shows an exemplary RAR message in which these parameters are arranged into six (6) eight-bit octets. In some instances, the RAR can also include a “backoff indicator,” by which the eNB can instruct the UE to back off for some time before retrying a RACH attempt. As mentioned above, the UE can use the received RTT to adjust its transmission window in order to obtain UL synchronization. The RAR is scheduled on a DL shared channel (e.g., PDSCH) and is indicated on a DL control channel (e.g., PDCCH) using an identity reserved for RARs. All UEs that transmitted a RA preamble monitor PDCCH for RAR scheduling within a time window after their preamble transmissions.

To detect and decode the RAR, UE monitors its SpCell PDCCH based on a RA-RNTI, rather than a C-RNTI (e.g., included in the RAR) that is typically used on PDCCH/PDSCH for RRC_CONNECTED UEs. The exact RA-RNTI value monitored by the UE is derived from the selected preamble, i.e., the RA-RNTI used by the network in msg2/RAR is uniquely associated with the time-frequency resource used by the UE to transmit the RACH preamble for msg1. Hence, if multiple UEs collided by selecting the same preamble in the same time-frequency resource in msg2, they would each receive the RAR with the same RA-RNTI. In other words, the eNB will detect the presence of a particular preamble but not how many UEs concurrently transmitted that particular preamble.

If the UE does not detect a RAR within the time window, it declares a failed attempt and repeats step 1 using an increased transmission power level for the preamble (or msg1). This continues until the UE succeeds or until a maximum number of attempts is reached, upon which the UE declares a RACH failure.

The received UL grant to be used in Step 3 is essentially a pointer (e.g., to a location on the UL time/frequency resource grid) that informs the UE exactly which subframes (time) to transmit in and what resource blocks (frequency) to use. The higher layers indicate the 20-bit UL Grant to the PHY, as defined in 3GPP TS 36.321 and 36.213. In the LTE PHY, this is referred to the RAR Grant and is carried on the PDCCH by a specific format of downlink control information (DCI). The RAR Grant size is intended to balance between minimizing number of bits to convey the resource assignment while providing some resource assignment flexibility for the eNB scheduler. In general, the length of the PHY message depends on the system bandwidth.

In step 3, upon correct reception of the RAR in step 2, the UE is time synchronized with the eNB. Before any transmission can take place, a unique identity C-RNTI is assigned. The UE transmission in this step (referred to as “msg3”) uses the UL channel radio resources assigned in step 2. Additional message exchange might also be needed depending on the UE state, as indicated in FIG. 6 by the arrows drawn with dashed lines. In particular, if the UE is not known in the eNB, then some signaling is needed between the eNB and the core network.

The msg 3 is the UE's first scheduled uplink transmission on the PUSCH. It conveys an actual RRC procedural message, such as an RRCConnectionRequest, and RRCResumeRequest, etc. It is addressed to the temporary C-RNTI allocated in RAR during step 2 and carries the C-RNTI or an initial UE identity.

In case of a preamble collision having occurred at step 1, the colliding UEs will receive the same temporary C-RNTI through the RAR and will also transmit colliding msg3's that use the same UL time-frequency resources obtained via the UL grant. This may result in interference such that none of the colliding msg3's can be decoded, which results in HARQ negative feedback (e.g., NACK) from the eNB and a retransmission by the UE. The colliding UEs restart the RACH procedure after reaching the maximum number of HARQ retransmissions, which may avoid the need of contention resolution (unless they select again the same preamble, which is unlikely).

However, if at least one UE msg3 is successfully decoded and acknowledged by positive HARQ feedback (e.g., ACK), the contention remains unresolved for the other UEs at this step. Even so, the MAC downlink msg4 (in step 4) allows a quick resolution of this contention.

In step 4, the eNB sends msg4 via RRC to possibly solve contention. The contention resolution message is addressed to the C-RNTI included in msg3 or, in none is included, to the temporary C-RNTI (e.g., sent in msg2). In the latter case, msg4 also echoes the UE identity contained in the RRC message (e.g., resume identifier, s-TMSI, etc.). The reason to distinguish these two cases is that if the UE is performing RACH during handover with CBRA, the target cell will allocate a C-RNTI in the handover command (prepared by target) which should be a unique C-RNTI. Hence, as an indication that the target cell detected msg3 (e.g., an RRCConfigurationComplete message), msg4 is sent to the same C-RNTI. The assumption is that the C-RNTI allocated by the target cell is unique and there is no source of confusion, i.e., other UEs that receive this msg4 recognize a different C-RNTI and understand that a collision has happened.

In the other case, when the UE does not have a C-RNTI allocated by the target, msg4 uses the temporary C-RNTI. In such case, the msg4 may be received by different UEs, so the eNB needs to indicate for which UE the msg3 has been decoded and that contention was resolved for that UE. That is done by the echoing back of the UE identifier in the RRC message (e.g., resume identifier, S-TMSI, etc.), which is very unlikely to also be the same.

In case of a collision followed by successful decoding of msg3 by the UE, HARQ feedback is transmitted by the UE only which detects its own UE identity (or C-RNTI); other UEs understand there was a collision, transmit no HARQ feedback, and can quickly exit the current RACH procedure and start another one.

Accordingly, the UE can take one of the following three actions upon reception of contention resolution msg4:
The UE correctly decodes msg4, detects its own identity, and sends back a positive acknowledgement (ACK).
The UE correctly decodes msg4 and discovers that it contains another UE's identity; it sends no feedback (DTX) but may reinitiate the RACH procedure.
The UE fails to decode msg4 or misses the UL grant; it sends no feedback (DTX).

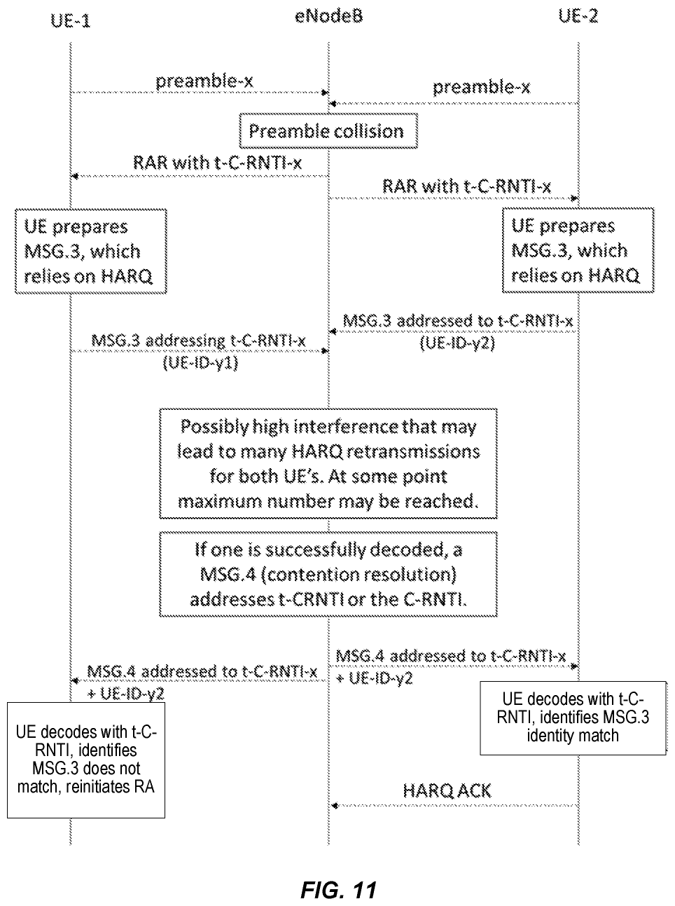

FIG. 11 shows a signal flow diagram illustrating a scenario where two UEs (UE-1 and UE-2 are attempting to access a cell using the same RA preamble (“preamble-X”). The operations in FIG. 11 correspond to various steps, messages, and/or operations discussed above. At the bottom of FIG. 11, UE-1 performs the second of the three actions mentioned above, while UE-2 performs the first of the three actions.

If the contention resolution timer expires or if the UE receives msg3 with its temporary C-RNTI but a different UE identifier, the UE considers contention resolution failed and re-initiates another random access attempt (e.g., as for UE-1 in FIG. 11). If the next attempt succeeds, it is not visible to the network that a collision occurred on a previous attempt. Note that since MAC does not consider a collision to be a failure case, it does not notify upper layers (e.g., RRC) that a collision has occurred. As discussed below, such information can be provided by the UE to the network in other ways, such as by a RACH report.

For LTE, the CBRA procedures discussed above are further specified in 3GPP TS 36.321 (v15.8.0) section 5. For NR, random access procedures are described in the MAC specification 3GPP TS 38.321 (v15.8.0) and parameters are configured by RRC, e.g., in SI or via handover (RRCReconfiguration with reconfigurationWithSync). For NR UEs, random access can be triggered in various scenarios, such as when the UE is in RRC_IDLE or RRC_INACTIVE and wants to transition to RRC_CONNECTED in the cell that it is camping on.

In NR, RACH configuration is broadcast in SIB1 as part of the servingCellConfigCommon (with both DL and UL configurations), where the RACH configuration is part of the uplinkConfigCommon field. The exact RACH parameters are contained in initialUplinkBWP IE, since they are considered part of the UL BWP that the UE shall access and search for RACH resources. In particular, the RACH parameters are in the rach-ConfigCommon field of the initialUplinkBWP IE.

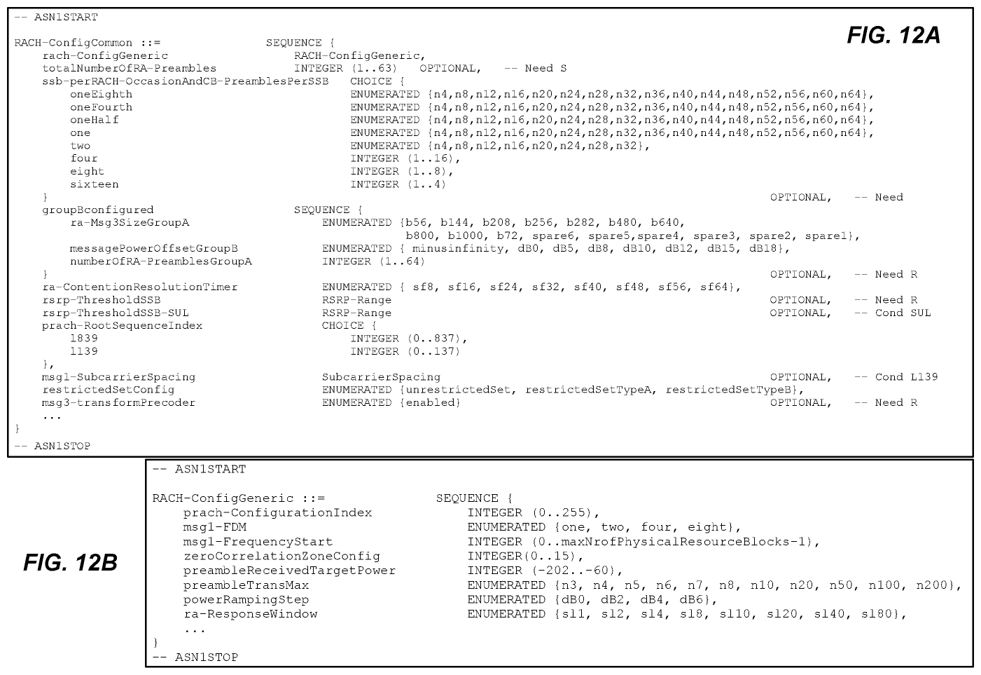

FIG. 12A shows an exemplary ASN.1 data structure for the RACH-ConfigCommon IE, of which the rach-ConfigCommon field is one instance. As shown in FIG. 12A, RACH-ConfigCommon includes a field rach-ConfigGeneric with additional “generic” RACH configuration parameters. FIG. 12B shows an exemplary ASN.1 data structure for a RACH-ConfigGeneric IE, of which the field rach-ConfigGeneric in FIG. 12A is one instance. The individual fields of the IEs shown in FIG. 12 are defined in more details in 3GPP TS 38.331 (v15.9.0).

Transmission by multiple antennas can increase the signal quality experienced by a receiver at the other end of a channel. Precoding can be used at the transmitter to form gain and phase for each antenna in an array in order to create a “beam” for the transmitted signal that, after passing through the channel, can be collected coherently by multiple antennas at the receiver. This process is also referred to as “beamforming” and creates an “array gain.” Use of beamforming is one cornerstone in the NR technology, and beams can be shaped in horizontal and vertical dimensions using advanced antenna systems (AAS).

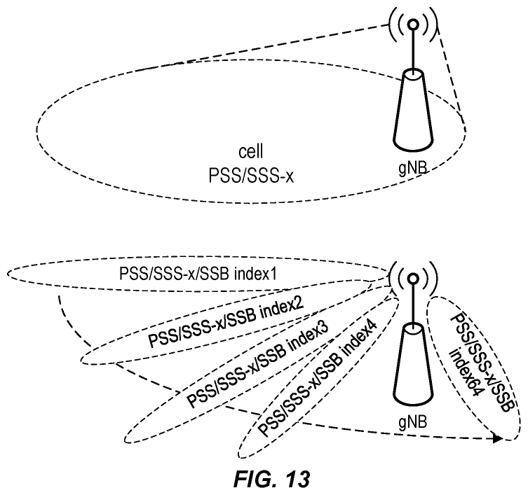

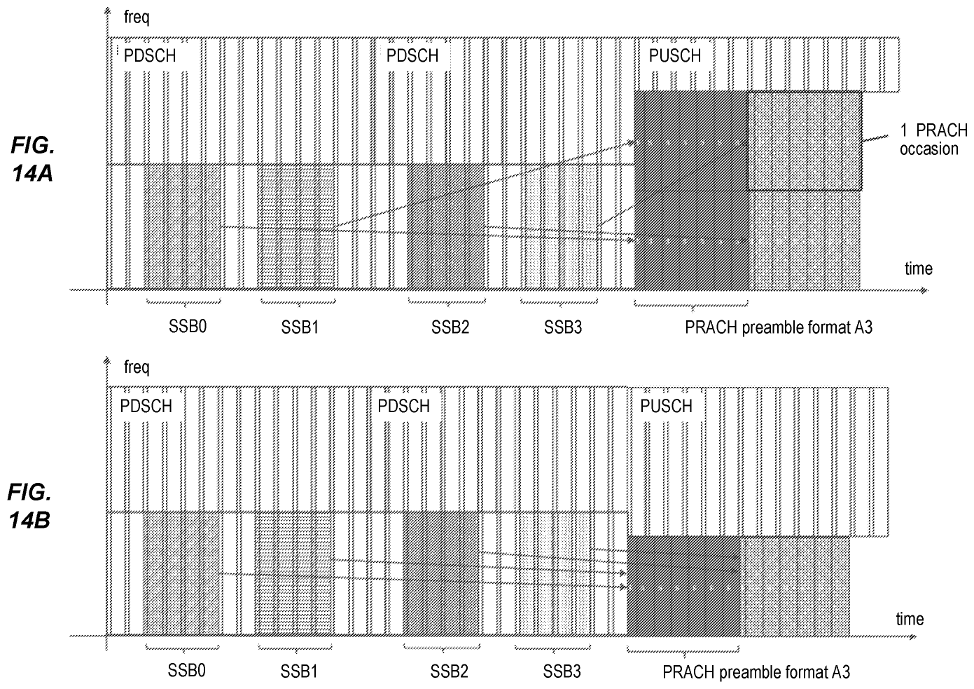

In NR, random access resource selection within a cell can be performed based on measurements performed on SSBs or CSI-RSs. In general, an NR cell may be comprised by a set of beams where PSS/SSS are transmitted in one or more DL beams, each beam associated with a different SSB index. FIG. 13 illustrates an exemplary arrangement where a cell includes 65 different downlink beams associated with SSB indices 0-64 respectively. For the same cell, these SSBs carry the same PCI and a master information block (MIB). To support UEs camping on an NR cell, they also carry the RACH configuration in SIB1.

This includes a mapping between an SSB detected by the UE at a given point in time and a corresponding PRACH configuration (e.g. time, frequency, preamble, etc.) to be used. The mapping between RACH resources and SSBs (or CSI-RS) is also provided as part of RACH-ConfigCommon). The most relevant paramers are:
SSBs-per-PRACH-occasion: ⅛, ¼, ½, 1, 2, 8 or 16, which represents the number of SSBs per RACH occasion;
CB-preambles-per-SSB preambles to each SSB: within a RACH occasion, how many preambles are allocated;

FIG. 14A shows a first exemplary configuration in which the number of SSBs per RACH occasion is one (1). In this example, the UE is under the coverage of SSB with index 2, and there will be a RACH occasion corresponding to SSB index 2. If the UE moves and is now under the coverage of another SSB with index 5, there will be another RACH occasion corresponding to SSB index. More generally, each SSB detected by a given UE would have its own RACH occasion. Hence, at the network side, upon detecting a preamble in a particular RACH occasion, the network knows exactly which SSB the UE has selected and, consequently, which DL beam is covering the UE. The network can continue the DL transmission of RAR, etc. via that beam.

In other words, when SSBs-per-PRACH-occasion=1, the 1:1 mapping between the RACH occasion and directly informs the network of the SSB received by the UE and the corresponding DL beam to use to communicate with the UE. However, each SSB typically maps to multiple preambles (e.g., with different cyclic shifts and/or Zadoff-Chu roots) within a PRACH occasion, so that it is possible to detect preambles from multiple UEs in the same PRACH occasion associated with a single SSB.

FIG. 14B shows a second exemplary configuration in which the number of SSBs per RACH occasion is two (2). A preamble received by the gNB in a particular RACH occasion indicates that one of two beams with different SSB indices are covering the UE. In such case, the network must distinguish these two beams in some manner, and/or perform a DL beam sweeping by transmitting RAR in both beams. This can be done simultaneously in both beams or sequentially in each beam, e.g., transmitting in one, waiting for a response from the UE, and if absent, transmitting in the other.

If the UE selects an SSB based on measurements performed in that cell and transmits with initial power level a selected preamble associated to the PRACH resource mapped to the selected SSB, the UE may or may not received a RAR within the RAR time window. According to the specifications, the UE may still perform preamble re-transmission until a maximum number of allowed transmissions is reached.

As described above, in LTE collisions may occur in a cell because multiple UEs have selected the same RACH preamble and, consequently could have transmitted in the same time/frequency PRACH resource transmission. In NR, collisions occur when multiple UEs select the same preamble associated to the beam (i.e. UEs may have to select the same SSB and CSI-RS), otherwise the timer/frequency RACH resource would be difference, as there may be different mapping between beams and RACH resources.

The contention resolution process in NR is similar to the one for LTE, described above. If multiple UEs under the coverage of the same DL beam (e.g., same SSB index) select the same preamble, they will also monitor PDCCH using the same RA-RNTI and receive the same RAR content, including the same UL grant for msg3 transmission. If both send msg3 according to the grant and if the gNB is able to decode at least one of them, a contention resolution msg4 is sent so the successful UE knows that contention is resolved. As in LTE, msg4 addresses the UE either using a C-RNTI or a temporary C-RNTI (TC-RNTI), and if msg4 addresses the UE with a TC-RNTI, it also includes in the MAC payload the UE identity used in msg3 (e.g., a resume identifier). The UE detecting this contention resolution msg4 is able to determine that a collision has occurred and that it needs to re-start RACH again. This is done by analysing the contention of the message or upon the expiry of the contention resolution timer.

If the content of the msg4 has the UE's TC-RNTI assigned in msg2, and the contention resolution identity in the payload matches the UE's identifier sent in msg3, the UE consider contention resolved and is not even aware that there was any collision. If it has its TC-RNTI and the contention resolution identity in the payload does not match its identifier sent in MSG.3, the UE declares a collision and performs further actions such as performing another RACH attempt declaring RACH failure. In summary, contention is unresolved and collision detected when either: 1) msg4 addresses TC-RNTI and UE Identities do not match; or 2) the UE's contention resolution timer expires. Similar to the existing LTE solution for RACH optimization, the UE would log the occurrence of that event upon these cases. The contention resolution mechanism for NR is further specified in 3GPP TS 38.321 (v15.8.0) section 5.1.5.

Assuming that in the initial attempt, the UE selected an SSB based on measurements performed in the cell and transmitted a selected preamble associated to the PRACH resource mapped to the selected SSB, using an initial power level. If the UE does not receive a RAR within the configured time window, the UE may perform preamble re-transmission up to a maximum number of allowed retransmissions.

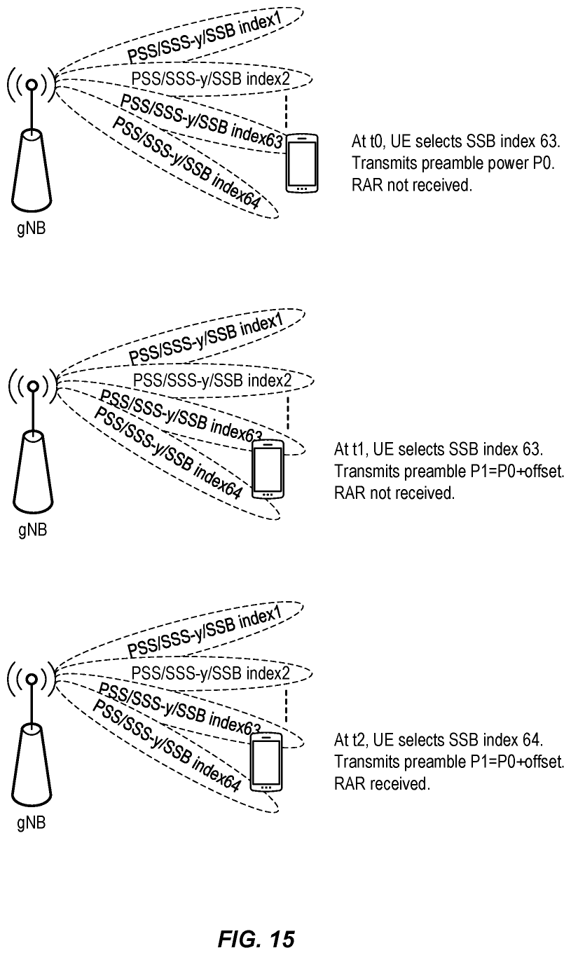

In NR as in LTE, at every preamble retransmission attempt, the UE may assume the same SSB as the previous attempt and perform power ramping as needed. A maximum number of attempts is also defined and controlled by the PREAMBLE_TRANSMISSION_COUNTER. On the other hand, the NR procedure differs from LTE in that at every preamble retransmission attempt, the UE may alternatively select a different beam (with a different SSB index), as long as that new beam has an acceptable quality (e.g., measurements above a configurable threshold). When a new beam is selected, the UE transmits the preamble at the same power most recently used in the previous beam. In other words, the UE does not perform power ramping and does not re-initiate the power to the initial power level. FIG. 15 illustrates an exemplary scenario where the UE initially transmits a preamble corresponding to SSB index 63 at power level P0 followed by power level P1, and then transmits a preamble corresponding to SSB index 64 at the same power level P1.

Based on this difference, a new variable called PREAMBLE_POWER_RAMPING COUNTER is defined in the NR MAC specifications (3GPP TS 38.321), in case the same beam is selected at a retransmission. In addition, the variable PREAMBLE_TRANSMISSION_COUNTER is used to limit the total number of attempts, regardless if the UE performs beam re-selection or power ramping at each attempt. For example, if the initial preamble transmission (e.g., for SSB index 63 in FIG. 15) does not succeed and the UE selects the same beam for power ramping (e.g., as in FIG. 15), PREAMBLE_POWER RAMPING_COUNTER is incremented by PREAMBLE_POWER_RAMPING_STEP such that the transmission power will be:

```
PREAMBLE_RECEIVED_TARGET_POWER =
preambleReceivedTargetPower +
  DELTA_PREAMBLE +
  1*PREAMBLE_POWER_RAMPING_STEP.
```

On the other hand, the UE selects a different beam (e.g., SSB index 64 in FIG. 15) rather than power ramping in the same beam, the PREAMBLE_POWER_RAMPING COUNTER is not incremented and the transmission power will be same as in the first transmission, i.e.:

PREAMBLE_RECEIVED_TARGET_POWER =
preambleReceivedTargetPower +
DELTA_PREAMBLE.

The NR preamble power ramping procedure is further specified in 3GPP TS 38.321 (v15.8.0) sections 5.1.1-5.1.4.

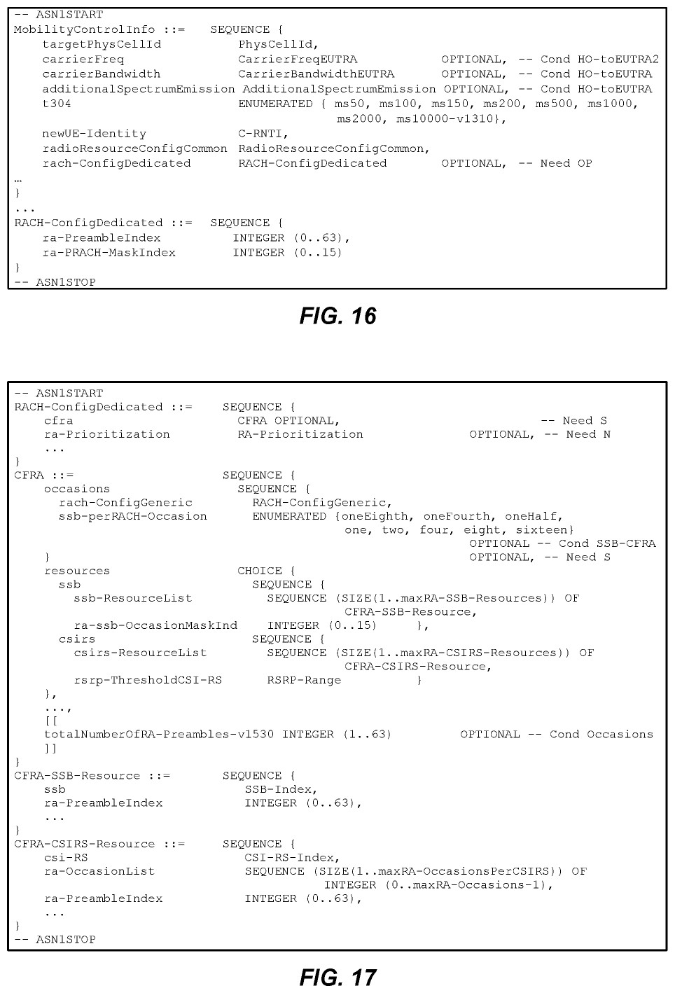

In LTE, the UE may be configured to perform CFRA, e.g., during handovers. The CFRA can be configured via an RRC MobilityControlInfo IE. FIG. 16 shows an exemplary ASN.1 data structure for a MobilityControlInfo IE, as well as the rach-ConfigDedicated field that includes the CFRA configuration. If the field rach-ConfigDedicated is absent from a received MobilityControlInfo IE, the UE performs CBRA; otherwise, the UE performs CFRA as specified in 3GPP TS 36.321 (v15.8.0) sections 5.1.2-5.1.4.

In general, an LTE UE that receives a CFRA configuration performs preamble transmissions and, if RAR is not received within the RAR time window, the UE can perform retransmission of the same configured dedicated preamble with power ramping. This can be done at the MAC layer until the UE reaches the maximum number of RACH attempts, at which point a failure is declared. From an RRC perspective, if that dedicated RACH configuration is provided during handovers, the UE starts failure timer T304 when the UE receives the handover command can continue RACH attempts until the failure timer T304 expires. This behavior is further specified in 3GPP TS 36.331 (v15.9.0) sections 5.3.5.4 and 5.3.5.6.

An NR may also be configured to perform CFRA during handovers. The CFRA can be configured by the reconfigurationWithSync IE of the RRCReconfiguration message, particularly the rach-ConflgDedicated field within the reconfigurationWithSync IE. FIG. 17 shows an exemplary ASN.1 data structure for a RACH-ConfigDedicated IE, of which the rach-ConfigDedicated field in reconfigurationWithSync is one instance.

Similar to NR CBRA, RACH resources for CFRA are mapped to beams (e.g., SSBs or CSI-RS) that may be measured by the UE. This can be done for all or a subset of beams in a particular cell. As such, the UE needs to select a beam for which CFRA resources have been configured in rach-ConfigDedicated. In the case of SSBs, that may be found in the ssb-ResourceList which is a SEQUENCE (SIZE(1 . . . maxRA-SSB-Resources)) OF CFRA-SSB-Resource in FIG. 17.

Also similar to NR CBRA, upon every failed random-access attempt up to the maximum, the UE has the option of power ramping on the same beam or selecting another beam. If the UE selects another beam for which CFRA resources have not been configured, the UE performs CBRA. Alternately, the UE can switch to a beam with a different type of RS, e.g., from SSB to CSI-RS in case CFRA is provided for CSI-RS resources on the selected beam. The NR random access resource selection procedure is further specified in 3GPP TS 38.321 (v15.8.0) section 5.1.2.

An NR UE can assess beam qualities from serving cell and/or neighbor cells via measurements on the synchronization block (SSB) and/or CSI-RS resources for the beam. The measurement configuration for NR is described in 3GPP TS 38.331 Section 5.5.1 but can be summarized as follows. The network may configure an RRC_CONNECTED UE to perform measurements and report them in accordance with the measurement configuration. The measurement configuration is provided by means of dedicated signaling, i.e., using a RRCReconfiguration message. The network may configure the UE to perform NR measurements and/or inter-RAT measurements of E-UTRA frequencies.

The network may configure the UE to report the following measurement information based on SS/PBCH blocks (SSBs):
Measurement results per SS/PBCH block;
Measurement results per cell based on SS/PBCH block(s);
SS/PBCH block(s) indexes.
   The network may configure the UE to report the following measurement information based on CSI-RS resources:
Measurement results per CSI-RS resource;
Measurement results per cell based on CSI-RS resource(s);
CSI-RS resource measurement identifiers.
   The measurement configuration can include the following parameters:
Measurement objects (MO): A list of objects on which the UE shall perform the measurements.
   For intra-frequency and inter-frequency measurements, a measurement object indicates the frequency/time location and subcarrier spacing of reference signals to be measured. Associated with this measurement object, the network may configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.
   The measObjectIld of the MO which corresponds to each serving cell is indicated by servingCellMO within the serving cell configuration.
   For inter-RAT E-UTRA measurements a measurement object is a single E-UTRA carrier frequency. Associated with this E-UTRA carrier frequency, the network can configure a list of cell specific offsets, a list of ‘blacklisted’ cells and a list of ‘whitelisted’ cells. Blacklisted cells are not applicable in event evaluation or measurement reporting. Whitelisted cells are the only ones applicable in event evaluation or measurement reporting.
Reporting configurations: A list of reporting configurations where there can be one or multiple reporting configurations per measurement object. Each reporting configuration consists of the following:
   Reporting criterion: The criterion that triggers the UE to send a measurement report. This can either be periodical or a single event description;
   RS type: The RS that the UE uses for beam and cell measurement results (SS/PBCH block or CSI-RS).
   Reporting format: The quantities per cell and per beam that the UE includes in the measurement report (e.g., RSRP) and other associated information such as the maximum number of cells and the maximum number beams per cell to report.

Optimization of the RACH configuration (e.g., in a cell) is a 3GPP Rel-9 self-optimizing network (SON) feature that can improve the system performance of a wireless network, such as a cellular network. A poorly configured RACH may result in higher call setup and handover delays due to frequent RACH collisions, or low preamble-detection probability and limited coverage. The amount of UL resources reserved for RACH in a cell also affects the system capacity. Therefore, network operators should take care that the RACH parameters are set appropriately, considering factors such as the RACH load, UL interference, UL/DL traffic patterns, base station antenna configuration, and population size and/or density under the cell's coverage. Surrounding cells may also affect a particular cell.

This task becomes more complicated because these factors may change dynamically. For example, if the antenna tilt is changed in a cell, it will affect the rates of call arrival and handover in this cell and the surrounding cells, and therefore the RACH load per preamble in all those cells. A change in transmission power settings or handover thresholds may have similar effects.

Whenever such a network configuration change happens, the RACH self-optimization feature should automatically make appropriate measurements of the RACH performance and usage in all the affected cells and determine any necessary updates of the RACH parameters. Some useful measurements are reported by the UE, e.g., the number of RACH attempts needed to obtain access, time elapsed from the first attempt until access is finally granted, etc.

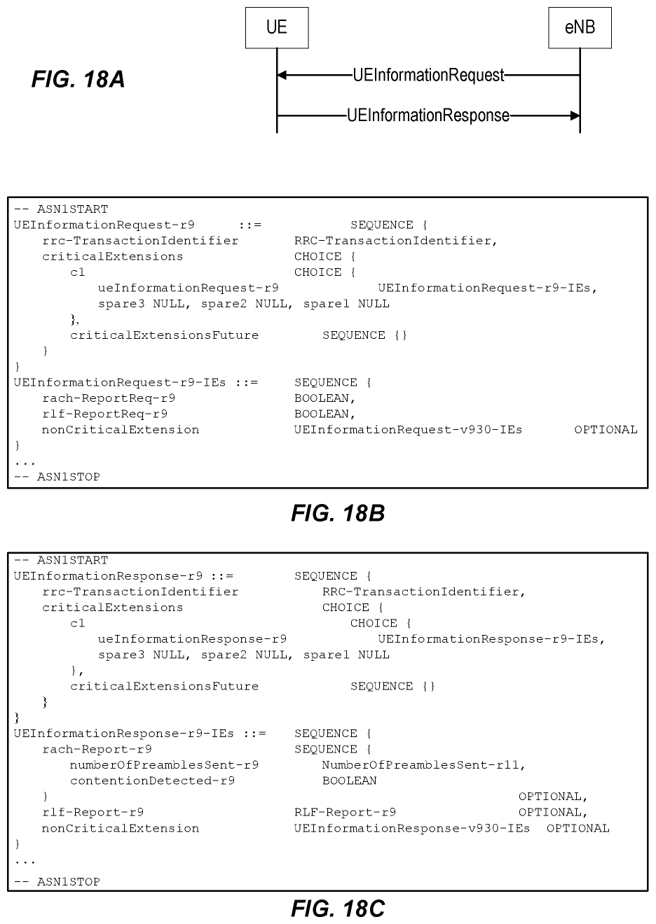

In LTE, the network can request the UE to report RACH information from random access procedures via the UE Information procedure in RRC. FIG. 18A shows a signal flow diagram for an exemplary successful LTE UE Information procedure. Initially, the eNB sends the UE a UEInformationRequest message. FIG. 18B shows an exemplary ASN.1 data structure for a UEInformationRequest message. The UE responds with a UEInformationResponse message, which can include a rach-Report-r9 field with information about the number of random-access preambles sent and whether contention was detected. FIG. 18C shows an exemplary ASN.1 data structure for a UEInformationResponse message. The UE Information procedure is also described in 3GPP TS 36.331 (v15.9.0) section 5.6.5.

Based on such reports, various RACH parameters that can be adjusted. For example, the network can adjust the allocation of RACH preambles between CBRA (with higher payload) and CFRA (with low payload). As another example, the network can adjust RACH back-off and/or transmission power ramping parameters used by UEs. Any other parameter may be adjusted if found useful by network operator.

In addition, the RACH optimization feature facilitates automatic configuration of PRACH parameters (e.g., PRACH resource configuration, preamble root sequence, cyclic shift configuration) to avoid preamble collisions with neighboring cells. The principle of this automatic configuration is similar to the SON feature of automatic physical cell identity (PCI) configuration SON feature. In particular, for LTE, the PRACH configuration information is included in the ‘X2 Setup’ and ‘eNB Configuration Update’ procedures, such that when a new eNB is initialized and learns about its neighbors via the ANR function, it can at the same time learn the neighboring eNB PRACH configuration(s). The new eNB can then select its own PRACH configuration to avoid conflicts with those of the neighboring eNBs.

Whenever a PRACH-related conflict is identified, configuration can be changed for one of the conflicting cells, but the algorithm for selecting which cell should change and in what manner is not specified. The network operator can also combine PRACH self-optimization with manual configuration if necessary, but this is typically more prone to errors and more time consuming than automatic RACH optimization.

One way that the network can control interference among UE RA procedures is by configuring UEs with a target power level for preambles at the network receiver. This parameter (called preambleReceivedTargetPower in LTE) can be configured for each UE via RRC, e.g., as part of the RACH-ConfigGeneric IE discussed above. Furthermore, the network can tune the preambleReceivedTargetPower based on RACH reports provided by UEs, discussed above.

Currently, the same preambleReceivedTargetPower is used for all the UEs operating across the entire coverage of a cell, regardless of UE distance from the network receiving antenna for the cell (e.g., associated with the base station serving the cell). As such, UEs often must perform trial and error to find an optimal RACH power level (e.g., via power ramping), which can introduce random-access delay, undesired and/or necessary UE energy consumption, and additional interference on the RACH.

Exemplary embodiments of the present disclosure can address these and other issues, problems, and/or difficulties with random access performance by techniques whereby an artificial intelligence or machine learning based algorithm (referred to as “AI/ML”) is provided with a set of input parameters related to random access performance and generates a set of output parameters (e.g., a configuration) for optimized and/or improved random access performance. In various embodiments, the AI/ML algorithm can be trained and executed by a wireless device or UE, a RAN node (e.g., eNB, gNB, ng-eNB, etc. or component thereof), or a combination thereof.

At a high level, for a particular serving cell, input parameters of the algorithm can include any of the following:
Cell and beam level measurement of the serving cell;
Cell and beam level measurement of the inter- and intra-frequency neighbor cells;
Measurement of the uplink resources used by the UEs, e.g., SRS measurements;
Interference measurement performed by the radio unit(s) of the serving cell and neighbor cells; and
UE timing advance.
   At a high level, output parameters of the algorithm for a particular UE in the serving cell can include any of the following:
Initial power level to be used by UE per beam;
Initial power level to be used by UE per beam per measurement threshold;
Power ramping step per beam; and
Maximum number of RACH attempts (i.e., preamble transmissions).

Exemplary embodiments can provide various benefits, advantages, and solutions to exemplary problems described herein. For example, such techniques can assist a UE to choose a Preamble_Received_Target_Power more accurately according to the UE's current situation in the serving cell. In fact, the optimized Preamble_Received_Target_Power can be chosen based on the DL/UL measurements as well as other information such as timing advance and UE location information. An optimized Preamble_Received_Target_Power can facilitate UE success on first attempt of a RACH procedure (so long as there are no collisions with other UEs) and reduce random access delay. This can be particularly important for delay sensitive services, e.g., URLLC in NR. In addition, by facilitating UE success with one or a minimal number of random access attempts, such techniques can reduce the UL interference among neighboring cells operating at the same frequency and can reduce energy consumption by the UE in relation to random access.

In some embodiments, the both the training and execution of the AI/ML based algorithm for RACH optimization can be performed by a RAN node, e.g., a gNB-DU or a gNB-CU. If the algorithm is placed at gNB-CU, it can determine and/or provide optimal RACH resources (e.g., optimal initial preamble transmission power, optimal set of beams to be used by RACH, etc.) for each bandwidth part (BWP) of each cell served by gNB-DUs owned by the gNB-CU. If the algorithm is placed at gNB-DU, it can determine and/or provide such optimal RACH resources for each bandwidth part (BWP) of each cell served by that particular gNB-DU.

At a high level, AI/ML can find a predictive function between inputs and outputs of a given dataset. The predictive function (or mapping function) can be generated in a training phase, based on knowledge of inputs and outputs in a training dataset. More specifically, the training phase determines a model of such that given input x produces an output y, i.e., f(x)→y. In contrast, the execution phase comprises predicting an output for inputs not in the training dataset.

In various embodiments, a RAN node can use its internal measurements as well as the measurement received from the UEs as input to train the AI/ML algorithm. The RAN node may, for instance, train the ML/AI algorithm using any of the following inputs, e.g., as single values or as time-series of measurements:
Information related to the cell and beam level link quality of the serving cell measured on the reference signals (RS) that may be beamformed such as SSB resources, CSI-RS resources that can be used for initial access or any RACH procedure in general (e.g., beam failure recovery, handover, request for other SI, etc.);
Information related to the cell and beam level link quality of the neighbor cells measured on the reference signals (RS) that may be beamformed such as SSB resources, CSI-RS resources that can be used for initial access or any RACH procedure in general (e.g., beam failure recovery, handover, request for other SI, etc.);
Beam relation information among the serving and neighbor cells;
Timing advance collected for different UEs with location information;
UL SRS measurements collected for different UEs;
RACH reports from different UEs;
Information related to the UE type, such as UE model and/or manufacturer, receiver type used by the UE, number of antennas, etc.;
UE geographical information; and
UE precoding matrix indicator (PMI).

In some embodiments, the network can construct a training dataset from successful RACH reports (outputs, y) and related beam measurements (corresponding inputs, x). In other embodiments, the network can construct a training dataset from connection establishment failure (CEF) reports (outputs, y) and related beam measurements (corresponding inputs, x). In other embodiments, the network can construct a training dataset from successful received RACH (outputs, y) and UE measurement on neighboring cells or frequencies after RACH was successfully decoded (corresponding inputs, x). In other embodiments, the network can construct a training dataset from CEF reports (outputs, y) and UE measurement on neighboring cells or frequencies after RACH was successfully decoded (corresponding inputs, x). Any combination of these embodiments is also possible.

In some embodiments, a RAN node can request neighboring RAN nodes to provide measurements of SRS transmissions made by UEs in the serving cell, which can be used to estimate the interference caused by RACH transmission (output, y) for a certain input, x (e.g., beam measurements). Based on the received interference estimates, the network node serving the UE can select a desired RACH power level.

The RAN node can consider the model to be trained when a certain number of samples have been collected and/or processed, and/or when mapping function f reaches a desired level of accuracy. This can be determined, for example, by calculating the sum squared prediction error (Σ|(|f(x)−y|)|\hat{ }2).

In some embodiments, where the AI/ML model determines the optimal transmission power level and DL measurement threshold associated with each beam, the RAN node can indicate the relation between the input and output parameters to the UE various ways. In some embodiments, the RAN node can broadcast, or send in dedicated RRC signaling, one or more sets of {threshold range, initial power level} for each SSB/CSI-RS. This can be included in RACH-ConfigCommon or RACH-ConfigGeneric, for instance. The thresholds can be associated with measurement quantities (e.g., RSRP, RSRQ, SINR, etc.) for the particular reference signals. Table 2 below provides an example involving two beams (indices 1 and 2), in which three sets of {threshold range, initial power level} are provided for index 1 (i.e., each set covers a different threshold range) and two sets are provided for index 2. Given this information, a UE can determine an initial transmission power level based on the index for the selected beam and measurements made on the selected beam.

TABLE 2

| | Threshold | Initial power |
|---|---|---|
| Beam index | Range (dBm) | level (dBm) |
| 1 | −90 or lower | −70 dBm |
| 1 | −90 to −60 | −80 dBm |
| 1 | −60 or higher | −60 dBm |
| 2 | −100 or lower | −65 dBm |
| 2 | −100 or higher | −60 dBm |

In some embodiments, the one or more sets for a given SSB/CSI-RS can include other related RACH parameters, such as power ramping steps, maximum number of preamble transmissions before declaring a random-access failure, etc. For RRC_CONNECTED UEs, the network may also use dedicated RRC message to send the UE an optimal initial power level (and/or other RACH parameters) that are based on various current input parameters, such as the latest measurements provided by the UE, UE location, UE timing advance, etc. Latest measurements can include RSRP, RSRQ, SINR, etc. for SSB or CSI-RS, or other measurements (e.g., CQI, PHR) reported by the UE before initiating random access.

In some embodiments, the AI/ML model can provide various other outputs that can be provided to the UE as part of a random-access configuration (e.g., CBRA or CFRA). Some examples are described below.
One or more power ramping steps for RACH transmission attempts. In one example, the network node can provide a power ramping step per beam (i.e., beam-associated power ramping step). This parameter can be included in the aforementioned parameter set signaled for a given SSB/CSI-RS. In another example, the network node can provide a power ramping per threshold range, such as described above. In such case, depending on the threshold range of DL reference signals, transmission power for RACH attempts can be adjusted more or less aggressively until an optimum and/or preferred value is reached. In variant, the network node can provide one or more power ramping steps that are associated with both a DL RS beam and a threshold range.
Maximum number of RACH attempts (i.e., preamble transmission), which can be included in the parameter set signaled for a given SSB/CSI-RS.
Set of beams to be used by the UE for RACH access. The gNB can signal a different number of SSBs per RACH occasions depending on coverage of such SSB. For example, the gNB can include more SSBs per RACH occasion if the radio quality of those SSBs is below a certain threshold.

In other embodiments, the training of the AI/ML based algorithm for RACH optimization can be performed by a RAN node, e.g., a gNB-DU or a gNB-CU. If the algorithm is placed at gNB-CU, it can determine and/or provide optimal RACH resources (e.g., optimal initial preamble transmission power, optimal set of beams to be used by RACH, etc.) for each bandwidth part (BWP) of each cell served by gNB-DUs owned by the gNB-CU. If the algorithm is placed at gNB-DU, it can determine and/or provide such optimal RACH resources for each bandwidth part (BWP) of each cell served by that particular gNB-DU.

The RAN node can train the MUAI algorithm using any of the inputs discussed above. In contrast to other embodiments described above, however, the execution of the trained AI/ML algorithm can be performed by the UE. For example, upon training the AI/ML model, RAN node can send the model (and, optionally, the training dataset) to the UE. The UE can then use the model to select the initial preamble transmission power (or other parameters provided as model outputs) when performing random access in a cell to which the model relates.

For example, taking into account the above provisioned sets of {threshold range, power level, power ramping step, max preamble trans} for a given SSB/CSI-RS, the UE can select RACH transmission parameters for a given beam from the set whose threshold range contains the radio quality as measured in such a beam.

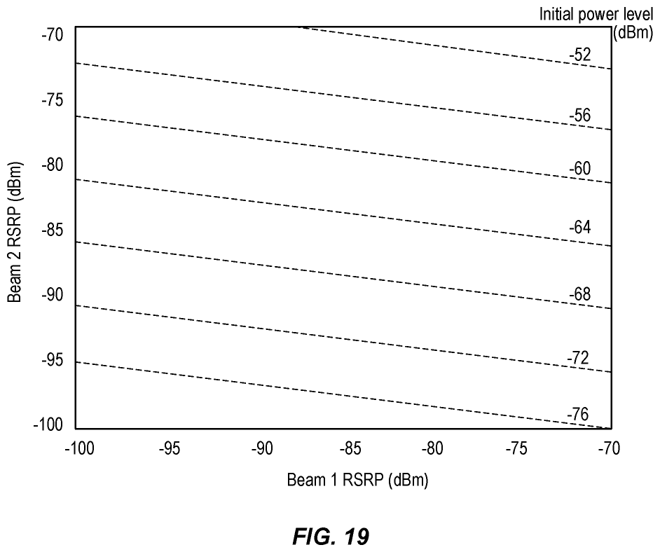

FIG. 19 shows an exemplary linear regression model in which initial transmission power level is an output based on inputs of UE measurements (e.g., RSRP) on two beams. IN other words, FIG. 19 shows the relation between the initial transmission power level and the beam measurement RSRP. In this example, the relation is:

initial power level=20+0.9*beam1Rsrp+0.1*beam2Rsrp

In this example, the network can provide the UE a model that identifies the desired inputs (beam1 RSRP, beam2 RSRP) and the model coefficients (w0=20, w1=0.9, w2=0.1).

In some embodiments, the UE can retrain the AI/ML model if the initial transmission power level produced by the model did not produce a desirable result. This could occur, for example, if the UE failed in a first RACH attempt without detecting any congestion, presumably due to inadequate initial preamble transmission power. To facilitate the retraining, the UE can request, and the RAN node can provide, any of the following measurements collected by the RAN node in relation to the model:
Radio resource management (RRM) measurements (e.g., RSRP, RSRQ, SINR, etc. of DL RS) for serving and neighbor cells, received from the UE or other UEs;
RACH reports;
Beam relation information among the serving and neighbor cells;
Interference measurements; and
UL SRS measurements;

In some embodiments, the UE may signal to the network that the AI/ML model trained by the network is not optimal, and/or send to the network the re-trained AI/ML model.

In the execution phase, the UE provides the AI/ML model with input information required by the model, which can include any of the following:
Instantaneous RRM measurement of DL reference signals such as SSB or CSI-RS of the UE's serving cell and one or more neighbor cells. Measurement quantities can include RSRP, RSRQ, SINR, etc.
Beam relation information among the serving and neighbor cells
UE's available location and timing advance.

Given these inputs, the execution of the model can provide one or more of the following outputs to be used for configuring the UE's random-access procedure:
Initial power level to be used per beam;
Initial power level to be used per beam per measurement threshold;
Power ramping step per beam;
Maximum number of RACH attempts (i.e., preamble transmissions); and
Set of beams to be used for random access.

In other embodiments, both the training and the execution of the AI/ML based algorithm for RACH optimization can be performed by the UE. For example, the model can be trained based on the UE's own measurement as well as other measurements provided by the network to the UE. In some of these embodiments, the network can provide the UE with model information that defines and/or specifies the model in some way, such as model type, model structure, model inputs, and model outputs. In some embodiments, the UE can indicate to the network the types of models that the UE supports, and the network can provide the model information based on this input from the UE. For example, the network can select between different types of models based on the UE input.

Given a general model by the network, the UE may train the model based on information related to the cell and beam level link quality of the serving cell and one or more neighbor cells. This can be measured by the UE on RS resources (e.g., SSB, CSI-RS) that are relevant to RACH procedures, including for initial access, beam failure recovery, handover, request for other SI, etc. In some embodiments, the UE may request, and the RAN node provide, additional relevant measurements to be used for training the AI/ML model. For example, the UE can request relevant measurements made by other devices of the same type as the UE. Such measurements can include:
RRM measurements collected by the RAN node for the serving and neighbor cells;
RACH reports collected by the RAN nodes;
Beam relation information among the serving and neighbor cells;
Interference measurements collected by the RAN nodes; and/or
UL SRS measurements collected by the RAN node.
   In some embodiments, the UE may also request other UEs in the serving cell to provide RRM measurements of serving and/or neighbor cells, e.g., via sidelink (SL) or D2D communications. In some embodiments, the UE can utilize its own location and timing advance information as model inputs.

Given these and any other relevant inputs, execution of the model can provide any of the outputs discussed above, to be used for configuring the UE's random-access procedure.

In some embodiments, the network can determine that RACH configurations for a cell need to be improved and/or optimized, such as by monitoring the number of RACH collisions reported by UEs. For example, if more than N failed RACH attempts have occurred in a predetermined duration, T, the network can train an AI/ML model based on any of the inputs discussed above. The newly trained model can then be executed by a RAN node or provided to UEs operating in the cell for execution by the UEs, in the manner discussed above.

Various types of AI/ML models can be used according to different embodiments of the present disclosure. Some exemplary model types include decision trees, random forest, feed forward neural networks, and convolutional neural networks. The type of model to be used can be based on the network capabilities, UE capabilities, model size and/or complexity, severity of random access problems in the cell, available inputs, necessary and/or desirable outputs, need for retraining, etc. In case the model is provided to UEs for execution, the network needs to trade-off the overhead in providing the model to UEs in the cell versus the benefits of having the model at the UE. As another example, the necessary size and/or complexity of the model may be dependent on the severity of RACH collisions in cells of the network. As another example, if the UE should re-train the model, neural-networks are able to do updates without requiring the entire training dataset, in contrast to tree-based methods such as random forest.

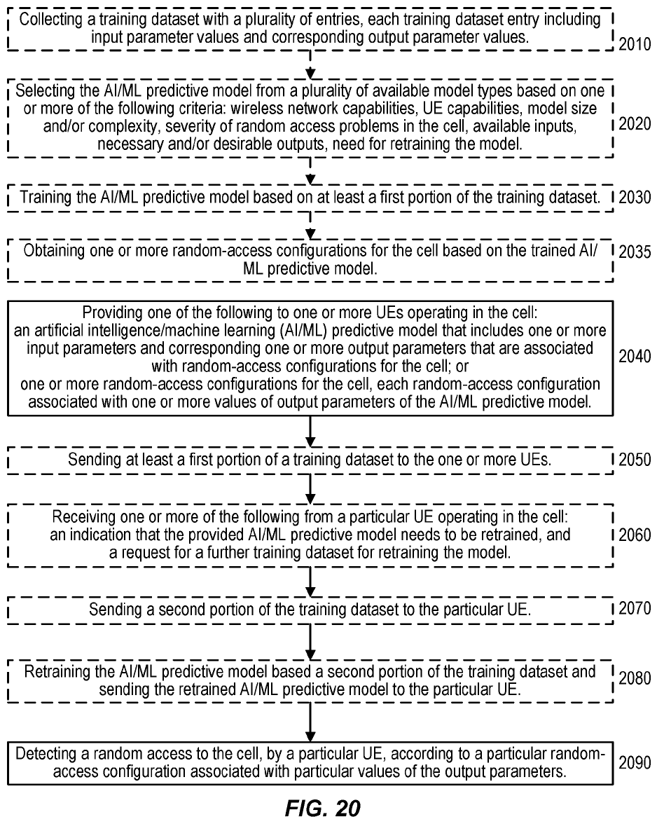

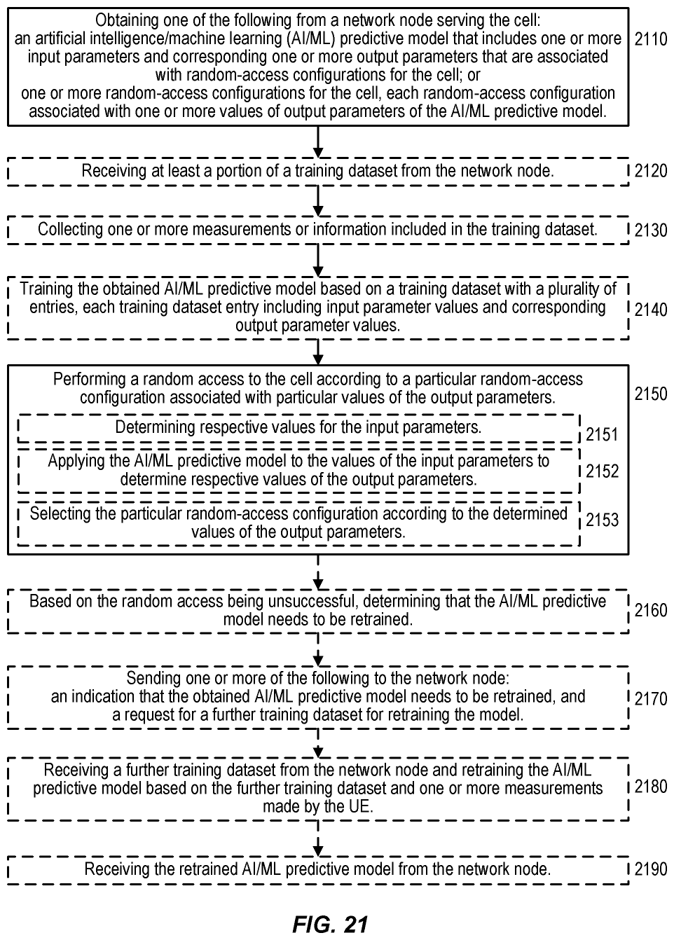

These embodiments described above can be further illustrated with reference to FIGS. 20-21, which depict exemplary methods (e.g., procedures) for a network node and a UE, respectively. Put differently, various features of the operations described below correspond to various embodiments described above. Furthermore, the exemplary methods shown in FIGS. 20-21 can be used cooperatively to provide various exemplary benefits and/or advantages described herein. Although FIGS. 20-21 show specific blocks in particular orders, the operations of the exemplary methods can be performed in different orders than shown and can be combined and/or divided into blocks with different functionality than shown. Optional blocks or operations are indicated by dashed lines.

In particular, FIG. 20 shows a flow diagram of an exemplary method (e.g., procedure) for a network node to configure random access by one or more UEs in a cell of the wireless network, according to various exemplary embodiments of the present disclosure. The exemplary method can be performed by a network node (e.g., base station, eNB, gNB, en-gNB, etc., or component thereof) such as described herein with reference to other figures.

The exemplary method can include the operations of block 2040, where the network node can provide one of the following to one or more UEs operating in the cell:
an AI/ML predictive model that includes one or more input parameters and corresponding one or more output parameters that are associated with random-access configurations for the cell; or
one or more random-access configurations for the cell, each random-access configuration associated with one or more values of output parameters of the AI/ML predictive model.
   The exemplary method can also include the operations of block 2090, where the network node can detect a random access to the cell, by a particular UE, according to a particular random-access configuration associated with particular values of the output parameters.

In some embodiments, the exemplary method can also include the operations of block 2010, where the network node can collect a training dataset with a plurality of entries. Each training dataset entry can include input parameter values and corresponding output parameter values. In some of these embodiments, the training dataset can include one or more of the following:
measurements of DL signals made by UEs operating in the cell;
measurements of UL signals transmitted by UEs operating in the cell;
measurements from one or more network nodes serving neighbor cells;
random access reports by UEs operating in the cell;
connection establishment failure reports by UEs operating in the cell;
location information for UEs operating in the cell; and
timing advance for UEs operating in the cell.

In some of these embodiments, the respective training dataset entries can include one or more of the following input parameter values:
one or more measurements made by a UE on neighboring cells or frequencies,
one or more beam measurements made by a UE in the cell, and
   In addition, the respect training dataset entries can include one or more of the following corresponding output parameter values:
an indication of failed or successful random access to the cell, and
an indication of failed or successful connection establishment.

In some embodiments, the provided AI/ML predictive model (e.g., provided in block 2040) can be untrained and the exemplary method can also include the operations of block 2050, where the network node can send at least a first portion of the training dataset (e.g., collected in block 2010) to the one or more UEs.

In other embodiments, the exemplary method can also include the operations of block 2030, where the network node can train the AI/ML predictive model based on at least a first portion of the training dataset. In such embodiments, the trained AI/ML predictive model is provided to the one or more UEs (e.g., in block 2040).

In some embodiments, the exemplary method can also include the operations of block 2060, where the network node can receive one or more of the following from a particular UE operating in the cell: an indication that the provided AI/ML predictive model needs to be retrained, and a request for a further training dataset for retraining the model. In such embodiments, the exemplary method can also include the operations of either block 2070 or block 2080. In block 2070, the network node can send a second portion of the training dataset to the particular UE. In block 2080, the network node can retrain the AI/ML predictive model based a second portion of the training dataset and send the retrained AI/ML predictive model to the particular UE.

In other embodiments, the exemplary method can also include the operations of block 2035, where the network node can obtain the one or more random-access configurations for the cell based on the trained AI/ML predictive model. In such embodiments, the obtained random-access configurations are provided to the one or more UEs (e.g., in block 2040) via broadcast in the cell.

In some embodiments, the exemplary method can also include the operations of block 2020, where the network node can select the AI/ML predictive model from a plurality of available model types based on one or more of the following criteria: wireless network capabilities, UE capabilities, model size and/or complexity, severity of random access problems in the cell, available inputs, necessary and/or desirable outputs, need for retraining the model.

In some embodiments, the input parameters to the AI/ML predictive model can include any of the following:
cell- and beam-level link quality of the cell;
cell- and beam-level link quality of the one or more neighbor cells;
relations between beams of the cell and the neighbor cells;
UE timing advance;
UE location;
UE precoding matrix indicator (PMI);
strength or quality of uplink (UL) reference signals received from UEs;
random access collisions reported by UEs; and
one or more of the following UE-related information: model, class, type, manufacturer, receiver type, and number of antennas.

In some embodiments, the output parameters to the AI/ML predictive model can include any of the following:
one or more power levels for an initial transmission of a random-access preamble,
one or more measurement thresholds corresponding to the power levels,
one or more power ramping steps for retransmissions of the random-access preamble,
maximum number of preamble retransmissions before declaring random access failure, and
set of downlink (DL) beams to be used for random access.

In some embodiments, the AI/ML predictive model can include, for each beam of one of more DL beams of the cell, one or more relations between a measurement range of a reference signal of the beam and a corresponding power level for an initial transmission of a random-access preamble.

In addition, FIG. 21 shows a flow diagram of an exemplary method (e.g., procedure) for a UE to perform random access in a cell of a wireless network, according to various exemplary embodiments of the present disclosure. The exemplary method can be performed by a UE (e.g., wireless device, IoT device, etc., or component thereof) such as described herein with reference to other figures.

The exemplary method can include the operations of block 2110, where the UE can receive one of the following from a network node serving the cell:
an AI/ML predictive model that includes one or more input parameters and corresponding one or more output parameters that are associated with random-access configurations for the cell; or
one or more random-access configurations for the cell, each random-access configuration associated with one or more values of output parameters of the AI/ML predictive model.

The exemplary method can also include the operations of block 2150, where the UE can perform a random access to the cell according to a particular random-access configuration associated with particular values of the output parameters.

In some embodiments, the one or more random-access configurations are obtained (e.g., in block 2110) via broadcast in the cell. In other embodiments, the obtained AI/ML predictive model (e.g., in block 2110) has been trained by the network node.

In other embodiments, the obtained AI/ML predictive model is untrained. In such embodiments, the exemplary method can also include the operations of block 2140, where the UE can train the obtained AI/ML predictive model based on a training dataset with a plurality of entries, with each training dataset entry including input parameter values and corresponding output parameter values. In some of these embodiments, the exemplary method can also include the operations of block 2120, where the UE can receive at least a portion of the training dataset from the network node, including one more of the following:
measurements of downlink (DL) signals made by UEs operating in the cell;
measurements of uplink (UL) signals transmitted by UEs operating in the cell;
measurements from one or more network nodes serving neighbor cells;
random access reports by UEs operating in the cell;
connection establishment failure reports by UEs operating in the cell;
location information for UEs operating in the cell; and
timing advance for UEs operating in the cell.

In some of these embodiments, each of the training dataset entries received from the network node can include one or more of the following input parameter values:
one or more measurements made by a UE on neighboring cells or frequencies,
one or more beam measurements made by a UE in the cell, and
   In addition, the respect training dataset entries can include one or more of the following corresponding output parameter values:
an indication of failed or successful random access to the cell, and
an indication of failed or successful connection establishment.

In some embodiments, the exemplary method can also include the operations of block 2110, where the UE can collect one or more of the following included in the training dataset:
UE measurements (i.e., by the UE) of DL signals in the wireless network;
information about the UE's random access attempts in the cell;
information about the UE's connection establishment attempts in the cell;
UE location information; and
UE timing advance.
   For example, the collection operation in block 2110 can be performed during the UE's operations in or proximate to the cell.

In some embodiments, performing the random access in block 2150 can include the operations of sub-blocks 2151-2153. In sub-block 2151, the UE can determine respective values for the input parameters. In sub-block 2152, the UE can apply the AI/ML predictive model to the values of the input parameters to determine respective values of the output parameters. In sub-block 2153, the UE can select the particular random-access configuration (i.e., used in block 2150) according to the determined values of the output parameters.

In some embodiments, the exemplary method can also include the operations of blocks 2160-2170. In block 2160, based on the random access (e.g., in block 2150) being unsuccessful, the UE can determine that the AI/ML predictive model needs to be retrained. In block 2170, the UE can send one or more of the following to the network node: an indication that the obtained AI/ML predictive model needs to be retrained, and a request for a further training dataset for retraining the model.

Additionally, these embodiments can also include the operations of block 2180 or block 2190. In block 2180, the UE can receive a further training dataset from the network node and retraining the AI/ML predictive model based on the further training dataset and one or more measurements made by the UE. In block 2190, the UE can receive the retrained AI/ML predictive model from the network node.

In some embodiments, the input parameters to the AI/ML predictive model can include any of the following:
cell- and beam-level link quality of the cell;
cell- and beam-level link quality of the one or more neighbor cells;
relations between beams of the cell and the neighbor cells;
UE timing advance;
UE location;
UE precoding matrix indicator (PMI);
strength or quality of uplink (UL) reference signals received from UEs;
random access collisions reported by UEs; and
one or more of the following UE-related information: model, class, type, manufacturer, receiver type, and number of antennas.

In some embodiments, the output parameters to the AI/ML predictive model can include any of the following:
one or more power levels for an initial transmission of a random-access preamble,
one or more measurement thresholds corresponding to the power levels,
one or more power ramping steps for retransmissions of the random-access preamble,
maximum number of preamble retransmissions before declaring random access failure, and
set of downlink (DL) beams to be used for random access.

In some embodiments, the AI/ML predictive model can include, for each beam of one of more DL beams of the cell, one or more relations between a measurement range of a reference signal of the beam and a corresponding power level for an initial transmission of a random-access preamble.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

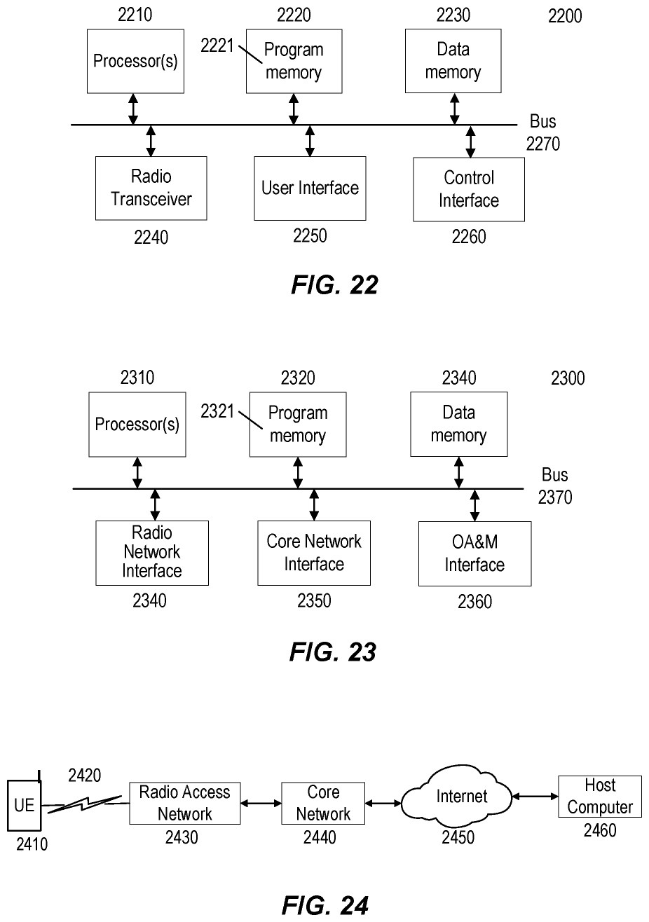

FIG. 22 shows a block diagram of an exemplary wireless device or user equipment (UE) 2200 (hereinafter referred to as “UE 2200”) according to various embodiments of the present disclosure, including those described above with reference to other figures. For example, UE 2200 can be configured by execution of instructions, stored on a computer-readable medium, to perform operations corresponding to one or more of the exemplary methods described herein.

UE 2200 can include a processor 2210 (also referred to as “processing circuitry”) that can be operably connected to a program memory 2220 and/or a data memory 2230 via a bus 2270 that can comprise parallel address and data buses, serial ports, or other methods and/or structures known to those of ordinary skill in the art. Program memory 2220 can store software code, programs, and/or instructions (collectively shown as computer program product 2221 in FIG. 22) that, when executed by processor 2210, can configure and/or facilitate UE 2200 to perform various operations, including operations corresponding to various exemplary methods described herein. As part of or in addition to such operations, execution of such instructions can configure and/or facilitate UE 2200 to communicate using one or more wired or wireless communication protocols, including one or more wireless communication protocols standardized by 3GPP, 3GPP2, or IEEE, such as those commonly known as 5G/NR, LTE, LTE-A, UMTS, HSPA, GSM, GPRS, EDGE, 1×RTT, CDMA2000, 802.11 WiFi, HDMI, USB, Firewire, etc., or any other current or future protocols that can be utilized in conjunction with radio transceiver 2240, user interface 2250, and/or control interface 2260.

As another example, processor 2210 can execute program code stored in program memory 2220 that corresponds to MAC, RLC, PDCP, and RRC layer protocols standardized by 3GPP (e.g., for NR and/or LTE). As a further example, processor 2210 can execute program code stored in program memory 2220 that, together with radio transceiver 2240, implements corresponding PHY layer protocols, such as Orthogonal Frequency Division Multiplexing (OFDM), Orthogonal Frequency Division Multiple Access (OFDMA), and Single-Carrier Frequency Division Multiple Access (SC-FDMA). As another example, processor 2210 can execute program code stored in program memory 2220 that, together with radio transceiver 2240, implements device-to-device (D2D) communications with other compatible devices and/or UEs.

Program memory 2220 can also include software code executed by processor 2210 to control the functions of UE 2200, including configuring and controlling various components such as radio transceiver 2240, user interface 2250, and/or control interface 2260. Program memory 2220 can also comprise one or more application programs and/or modules comprising computer-executable instructions embodying any of the exemplary methods described herein. Such software code can be specified or written using any known or future developed programming language, such as e.g., Java, C++, C, Objective C, HTML, XHTML, machine code, and Assembler, as long as the desired functionality, e.g., as defined by the implemented method steps, is preserved. In addition, or as an alternative, program memory 2220 can comprise an external storage arrangement (not shown) remote from UE 2200, from which the instructions can be downloaded into program memory 2220 located within or removably coupled to UE 2200, so as to enable execution of such instructions.

Data memory 2230 can include memory area for processor 2210 to store variables used in protocols, configuration, control, and other functions of UE 2200, including operations corresponding to, or comprising, any of the exemplary methods described herein. Moreover, program memory 2220 and/or data memory 2230 can include non-volatile memory (e.g., flash memory), volatile memory (e.g., static or dynamic RAM), or a combination thereof. Furthermore, data memory 2230 can comprise a memory slot by which removable memory cards in one or more formats (e.g., SD Card, Memory Stick, Compact Flash, etc.) can be inserted and removed.

Persons of ordinary skill will recognize that processor 2210 can include multiple individual processors (including, e.g., multi-core processors), each of which implements a portion of the functionality described above. In such cases, multiple individual processors can be commonly connected to program memory 2220 and data memory 2230 or individually connected to multiple individual program memories and or data memories. More generally, persons of ordinary skill in the art will recognize that various protocols and other functions of UE 2200 can be implemented in many different computer arrangements comprising different combinations of hardware and software including, but not limited to, application processors, signal processors, general-purpose processors, multi-core processors, ASICs, fixed and/or programmable digital circuitry, analog baseband circuitry, radio-frequency circuitry, software, firmware, and middleware.

Radio transceiver 2240 can include radio-frequency transmitter and/or receiver functionality that facilitates the UE 2200 to communicate with other equipment supporting like wireless communication standards and/or protocols. In some exemplary embodiments, the radio transceiver 2240 includes one or more transmitters and one or more receivers that enable UE 2200 to communicate according to various protocols and/or methods proposed for standardization by 3GPP and/or other standards bodies. For example, such functionality can operate cooperatively with processor 2210 to implement a PHY layer based on OFDM, OFDMA, and/or SC-FDMA technologies, such as described herein with respect to other figures.

In some exemplary embodiments, radio transceiver 2240 includes one or more transmitters and one or more receivers that can facilitate the UE 2200 to communicate with various LTE, LTE-Advanced (LTE-A), and/or NR networks according to standards promulgated by 3GPP. In some exemplary embodiments of the present disclosure, the radio transceiver 2240 includes circuitry, firmware, etc. necessary for the UE 2200 to communicate with various NR, NR-U, LTE, LTE-A, LTE-LAA, UMTS, and/or GSM/EDGE networks, also according to 3GPP standards. In some embodiments, radio transceiver 2240 can include circuitry supporting D2D communications between UE 2200 and other compatible devices.

In some embodiments, radio transceiver 2240 includes circuitry, firmware, etc. necessary for the UE 2200 to communicate with various CDMA2000 networks, according to 3GPP2 standards. In some embodiments, the radio transceiver 2240 can be capable of communicating using radio technologies that operate in unlicensed frequency bands, such as IEEE 802.11 WiFi that operates using frequencies in the regions of 2.4, 5.6, and/or 60 GHz. In some embodiments, radio transceiver 2240 can include a transceiver that is capable of wired communication, such as by using IEEE 802.3 Ethernet technology. The functionality particular to each of these embodiments can be coupled with and/or controlled by other circuitry in the UE 2200, such as the processor 2210 executing program code stored in program memory 2220 in conjunction with, and/or supported by, data memory 2230.

User interface 2250 can take various forms depending on the particular embodiment of UE 2200, or can be absent from UE 2200 entirely. In some embodiments, user interface 2250 can comprise a microphone, a loudspeaker, slidable buttons, depressible buttons, a display, a touchscreen display, a mechanical or virtual keypad, a mechanical or virtual keyboard, and/or any other user-interface features commonly found on mobile phones. In other embodiments, the UE 2200 can comprise a tablet computing device including a larger touchscreen display. In such embodiments, one or more of the mechanical features of the user interface 2250 can be replaced by comparable or functionally equivalent virtual user interface features (e.g., virtual keypad, virtual buttons, etc.) implemented using the touchscreen display, as familiar to persons of ordinary skill in the art. In other embodiments, the UE 2200 can be a digital computing device, such as a laptop computer, desktop computer, workstation, etc. that comprises a mechanical keyboard that can be integrated, detached, or detachable depending on the particular exemplary embodiment. Such a digital computing device can also comprise a touch screen display. Many exemplary embodiments of the UE 2200 having a touch screen display are capable of receiving user inputs, such as inputs related to exemplary methods described herein or otherwise known to persons of ordinary skill.

In some embodiments, UE 2200 can include an orientation sensor, which can be used in various ways by features and functions of UE 2200. For example, the UE 2200 can use outputs of the orientation sensor to determine when a user has changed the physical orientation of the UE 2200's touch screen display. An indication signal from the orientation sensor can be available to any application program executing on the UE 2200, such that an application program can change the orientation of a screen display (e.g., from portrait to landscape) automatically when the indication signal indicates an approximate 90-degree change in physical orientation of the device. In this exemplary manner, the application program can maintain the screen display in a manner that is readable by the user, regardless of the physical orientation of the device. In addition, the output of the orientation sensor can be used in conjunction with various exemplary embodiments of the present disclosure.

A control interface 2260 of the UE 2200 can take various forms depending on the particular exemplary embodiment of UE 2200 and of the particular interface requirements of other devices that the UE 2200 is intended to communicate with and/or control. For example, the control interface 2260 can comprise an RS-232 interface, a USB interface, an HDMI interface, a Bluetooth interface, an IEEE (“Firewire”) interface, an I²C interface, a PCMCIA interface, or the like. In some exemplary embodiments of the present disclosure, control interface 2260 can comprise an IEEE 802.3 Ethernet interface such as described above. In some exemplary embodiments of the present disclosure, the control interface 2260 can comprise analog interface circuitry including, for example, one or more digital-to-analog converters (DACs) and/or analog-to-digital converters (ADCs).

Persons of ordinary skill in the art can recognize the above list of features, interfaces, and radio-frequency communication standards is merely exemplary, and not limiting to the scope of the present disclosure. In other words, the UE 2200 can comprise more functionality than is shown in FIG. 22 including, for example, a video and/or still-image camera, microphone, media player and/or recorder, etc. Moreover, radio transceiver 2240 can include circuitry necessary to communicate using additional radio-frequency communication standards including Bluetooth, GPS, and/or others. Moreover, the processor 2210 can execute software code stored in the program memory 2220 to control such additional functionality. For example, directional velocity and/or position estimates output from a GPS receiver can be available to any application program executing on the UE 2200, including any program code corresponding to and/or embodying any exemplary embodiments (e.g., of methods) described herein.

FIG. 23 shows a block diagram of an exemplary network node 2300 according to various embodiments of the present disclosure, including those described above with reference to other figures. For example, exemplary network node 2300 can be configured by execution of instructions, stored on a computer-readable medium, to perform operations corresponding to one or more of the exemplary methods described herein. In some exemplary embodiments, network node 2300 can comprise a base station, eNB, gNB, or one or more components thereof. For example, network node 2300 can be configured as a central unit (CU) and one or more distributed units (DUs) according to NR gNB architectures specified by 3GPP. More generally, the functionally of network node 2300 can be distributed across various physical devices and/or functional units, modules, etc.

Network node 2300 can include processor 2310 (also referred to as “processing circuitry”) that is operably connected to program memory 2320 and data memory 2330 via bus 2370, which can include parallel address and data buses, serial ports, or other methods and/or structures known to those of ordinary skill in the art.

Program memory 2320 can store software code, programs, and/or instructions (collectively shown as computer program product 2321 in FIG. 23) that, when executed by processor 2310, can configure and/or facilitate network node 2300 to perform various operations, including operations corresponding to various exemplary methods described herein. As part of and/or in addition to such operations, program memory 2320 can also include software code executed by processor 2310 that can configure and/or facilitate network node 2300 to communicate with one or more other UEs or network nodes using other protocols or protocol layers, such as one or more of the PHY, MAC, RLC, PDCP, and RRC layer protocols standardized by 3GPP for LTE, LTE-A, and/or NR, or any other higher-layer (e.g., NAS) protocols utilized in conjunction with radio network interface 2340 and/or core network interface 2350. By way of example, core network interface 2350 can comprise the S1 or NG interface and radio network interface 2340 can comprise the Uu interface, as standardized by 3GPP. Program memory 2320 can also comprise software code executed by processor 2310 to control the functions of network node 2300, including configuring and controlling various components such as radio network interface 2340 and core network interface 2350.

Data memory 2330 can comprise memory area for processor 2310 to store variables used in protocols, configuration, control, and other functions of network node 2300. As such, program memory 2320 and data memory 2330 can comprise non-volatile memory (e.g., flash memory, hard disk, etc.), volatile memory (e.g., static or dynamic RAM), network-based (e.g., “cloud”) storage, or a combination thereof. Persons of ordinary skill in the art will recognize that processor 2310 can include multiple individual processors (not shown), each of which implements a portion of the functionality described above. In such case, multiple individual processors may be commonly connected to program memory 2320 and data memory 2330 or individually connected to multiple individual program memories and/or data memories. More generally, persons of ordinary skill will recognize that various protocols and other functions of network node 2300 may be implemented in many different combinations of hardware and software including, but not limited to, application processors, signal processors, general-purpose processors, multi-core processors, ASICs, fixed digital circuitry, programmable digital circuitry, analog baseband circuitry, radio-frequency circuitry, software, firmware, and middleware.

Radio network interface 2340 can comprise transmitters, receivers, signal processors, ASICs, antennas, beamforming units, and other circuitry that enables network node 2300 to communicate with other equipment such as, in some embodiments, a plurality of compatible user equipment (UE). In some embodiments, interface 2340 can also enable network node 2300 to communicate with compatible satellites of a satellite communication network. In some exemplary embodiments, radio network interface 2340 can comprise various protocols or protocol layers, such as the PHY, MAC, RLC, PDCP, and/or RRC layer protocols standardized by 3GPP for LTE, LTE-A, LTE-LAA, NR, NR-U, etc.; improvements thereto such as described herein above; or any other higher-layer protocols utilized in conjunction with radio network interface 2340. According to further exemplary embodiments of the present disclosure, the radio network interface 2340 can comprise a PHY layer based on OFDM, OFDMA, and/or SC-FDMA technologies. In some embodiments, the functionality of such a PHY layer can be provided cooperatively by radio network interface 2340 and processor 2310 (including program code in memory 2320).

Core network interface 2350 can comprise transmitters, receivers, and other circuitry that enables network node 2300 to communicate with other equipment in a core network such as, in some embodiments, circuit-switched (CS) and/or packet-switched Core (PS) networks. In some embodiments, core network interface 2350 can comprise the S1 interface standardized by 3GPP. In some embodiments, core network interface 2350 can comprise the NG interface standardized by 3GPP. In some exemplary embodiments, core network interface 2350 can comprise one or more interfaces to one or more AMFs, SMFs, SGWs, MMEs, SGSNs, GGSNs, and other physical devices that comprise functionality found in GERAN, UTRAN, EPC, 5GC, and CDMA2000 core networks that are known to persons of ordinary skill in the art. In some embodiments, these one or more interfaces may be multiplexed together on a single physical interface. In some embodiments, lower layers of core network interface 2350 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art.

In some embodiments, network node 2300 can include hardware and/or software that configures and/or facilitates network node 2300 to communicate with other network nodes in a RAN, such as with other eNBs, gNBs, ng-eNBs, en-gNBs, IAB nodes, etc. Such hardware and/or software can be part of radio network interface 2340 and/or core network interface 2350, or it can be a separate functional unit (not shown). For example, such hardware and/or software can configure and/or facilitate network node 2300 to communicate with other RAN nodes via the X2 or Xn interfaces, as standardized by 3GPP.

OA&M interface 2360 can comprise transmitters, receivers, and other circuitry that enables network node 2300 to communicate with external networks, computers, databases, and the like for purposes of operations, administration, and maintenance of network node 2300 or other network equipment operably connected thereto. Lower layers of OA&M interface 2360 can comprise one or more of asynchronous transfer mode (ATM), Internet Protocol (IP)-over-Ethernet, SDH over optical fiber, T1/E1/PDH over a copper wire, microwave radio, or other wired or wireless transmission technologies known to those of ordinary skill in the art. Moreover, in some embodiments, one or more of radio network interface 2340, core network interface 2350, and OA&M interface 2360 may be multiplexed together on a single physical interface, such as the examples listed above.

FIG. 24 is a block diagram of an exemplary communication network configured to provide over-the-top (OTT) data services between a host computer and a user equipment (UE), according to one or more exemplary embodiments of the present disclosure. UE 2410 can communicate with radio access network (RAN) 2430 over radio interface 2420, which can be based on protocols described above including, e.g., LTE, LTE-A, NR, NR-U, etc. For example, UE 2410 can be configured and/or arranged as shown in other figures discussed above.

RAN 2430 can include one or more terrestrial network nodes (e.g., base stations, eNBs, gNBs, controllers, etc.) operable in licensed spectrum bands, as well one or more network nodes operable in unlicensed spectrum (using, e.g., LAA or NR-U technology), such as a 2.4-GHz band and/or a 5-GHz band. In such cases, the network nodes comprising RAN 2430 can cooperatively operate using licensed and unlicensed spectrum. In some embodiments, RAN 2430 can include, or be capable of communication with, one or more satellites comprising a satellite access network.

RAN 2430 can further communicate with core network 2440 according to various protocols and interfaces described above. For example, one or more apparatus (e.g., base stations, eNBs, gNBs, etc.) comprising RAN 2430 can communicate to core network 2440 via core network interface 2450 described above. In some exemplary embodiments, RAN 2430 and core network 2440 can be configured and/or arranged as shown in other figures discussed above. For example, eNBs comprising an E-UTRAN 2430 can communicate with an EPC core network 2440 via an S1 interface. As another example, gNBs and ng-eNBs comprising an NG-RAN 2430 can communicate with a 5GC core network 2430 via an NG interface.

Core network 2440 can further communicate with an external packet data network, illustrated in FIG. 24 as Internet 2450, according to various protocols and interfaces known to persons of ordinary skill in the art. Many other devices and/or networks can also connect to and communicate via Internet 2450, such as exemplary host computer 2460. In some exemplary embodiments, host computer 2460 can communicate with UE 2410 using Internet 2450, core network 2440, and RAN 2430 as intermediaries. Host computer 2460 can be a server (e.g., an application server) under ownership and/or control of a service provider. Host computer 2460 can be operated by the OTT service provider or by another entity on the service provider's behalf.

For example, host computer 2460 can provide an over-the-top (OTT) packet data service to UE 2410 using facilities of core network 2440 and RAN 2430, which can be unaware of the routing of an outgoing/incoming communication to/from host computer 2460. Similarly, host computer 2460 can be unaware of routing of a transmission from the host computer to the UE, e.g., the routing of the transmission through RAN 2430. Various OTT services can be provided using the exemplary configuration shown in FIG. 24 including, e.g., streaming (unidirectional) audio and/or video from host computer to UE, interactive (bidirectional) audio and/or video between host computer and UE, interactive messaging or social communication, interactive virtual or augmented reality, etc.

The exemplary network shown in FIG. 24 can also include measurement procedures and/or sensors that monitor network performance metrics including data rate, latency and other factors that are improved by exemplary embodiments disclosed herein. The exemplary network can also include functionality for reconfiguring the link between the endpoints (e.g., host computer and UE) in response to variations in the measurement results. Such procedures and functionalities are known and practiced; if the network hides or abstracts the radio interface from the OTT service provider, measurements can be facilitated by proprietary signaling between the UE and the host computer.

The exemplary embodiments described herein provide novel techniques whereby an artificial intelligence or machine learning based algorithm (referred to as “AI/ML”) is provided with a set of input parameters related to random access performance and generates a set of output parameters (e.g., a configuration) for optimized and/or improved random access performance. Such embodiments can assist a UE or a network node to choose random access parameters more accurately according to the UE's current situation in a serving cell. As such, embodiments can facilitate UE success on first attempt of a RACH procedure and thereby reduce random access delay. This can be particularly important for delay sensitive services. In addition, by facilitating UE success with one or a minimal number of random access attempts, such techniques can reduce both UL interference among neighboring cells operating at the same frequency and energy consumption by the UE in relation to random access.

When used in NR UEs (e.g., UE 2410) and gNBs (e.g., gNBs comprising RAN 2430), exemplary embodiments described herein can provide various improvements, benefits, and/or advantages that improve the performance of various OTT services as experienced by service providers and end-users, including more consistent data throughout and lower latency without excessive UE energy consumption or other reductions in user experience.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein also include, but are not limited to, the following enumerated examples:

E1. A method for configuring random access procedures by one or more user equipment (UEs) in a cell of a wireless network, the method comprising:
obtaining an artificial intelligence/machine learning (AI/ML) predictive model that includes one or more input parameters and one or more output parameters, each output parameter being associated with a random-access configuration for the cell;
subsequently receiving values of the input parameters relating to a random access to the cell by a particular UE;
applying the AI/ML predictive model to the values of the input parameters to determine corresponding values for the output parameters for the random access by the particular UE.
   E2. The method of embodiment E1, wherein the input parameters include any of the following:
measurements of cell- and beam-level link quality of the cell;
measurements of cell- and beam-level link quality of the one or more neighbor cells;
relations between beams of the cell and the neighbor cells;
UE timing advance information;
UE location information;
UE precoding matrix indicator (PMI);
measurements of uplink (UL) reference signals transmitted by UEs;
random access collisions reported by UEs; and
information relating to UE configuration, such as model, manufacturer, receiver type, and number of antennas.
   E3. The method of any of embodiments E1-E2, wherein the output parameters include any of the following:
one or more power levels for an initial transmission of a random-access preamble,
one or more measurement thresholds corresponding to the power levels,
one or more power ramping steps for retransmissions of the random-access preamble,
maximum number of preamble retransmissions before declaring random access failure, and
set of downlink (DL) beams to be used for random access.
   E4. The method of any of embodiments E1-E3, wherein:
the predictive model includes one or more associations for each of one of more downlink (DL) beams of the cell; and
each association is between a measurement range of a reference signal of the beam and a power level for an initial transmission of a random-access preamble.
   E5. The method of any of embodiments E1-E4, wherein:
the method is performed by a network node in the wireless network; and
obtaining the AI/ML model comprises training the AI/ML model based on a training dataset with a plurality of entries, each entry including values of the input parameters and corresponding values of the output parameters.
   E6. The method of embodiment E5, further comprising sending the determined values of the output parameters to the particular UE.
   E7. The method of any of embodiments E5-E6, wherein obtaining the AI/ML model further comprises selecting the AI/ML model from a plurality of available model types based on one or more of the following criteria: wireless network capabilities, UE capabilities, model size and/or complexity, severity of random access problems in the cell, available inputs, necessary and/or desirable outputs, need for retraining the model.
   E8. The method of any of embodiments E5-E7, further comprising collecting the training dataset based on one more of the following actions:
receiving measurements from UEs operating in the cell;
receiving measurements from one or more network nodes serving neighbor cells;
receiving random access reports from UEs operating in the cell; and
determining location information and/or timing advance for UEs operating in the cell.
   E9. The method of any of embodiments E5-E8, wherein each entry in the training dataset includes one or more beam measurements made by a UE and corresponding one of the following reported by the UE after the beam measurements:
random access collision information; or
connection establishment failure information.
   E10. The method of any of embodiments E5-E8, wherein each entry in the training dataset includes one or more measurements made by a UE on neighboring cells or frequencies and corresponding one of the following before the measurements:
successful random access by the UE; or
connection establishment failure information reported by the UE.
   E11. The method of any of embodiments E1-E4, wherein:
the method is performed by the particular UE; and
obtaining the AI/ML model comprises receiving the AI/ML model from a network node in the wireless network.
   E12. The method of embodiment E11, further comprising performing a random access to the cell based on the determined values.
   E13. The method of embodiment E12, further comprising:
based on the random access being unsuccessful, determining that the AI/ML model needs to be retrained;
requesting, from the network node, a further training dataset for retraining the model; and
retraining the AI/ML mode based on the further training dataset and one or more measurements made by the particular UE.
   E14. A user equipment (UE) configured for random access in a cell of a wireless network, the UE comprising:
radio transceiver circuitry configured to communicate with a network node via the cell; and
processing circuitry operatively coupled to the radio transceiver circuitry, whereby the processing circuitry and the radio transceiver circuitry are configured to perform operations corresponding to any of the methods of embodiments E1-E4 and E11-E13.
   E15. A user equipment (UE) configured for random access in a cell of a wireless network, the UE being further arranged to perform operations corresponding to any of the methods of embodiments E1-E4 and E11-E13.
   E16. A non-transitory, computer-readable medium storing computer-executable instructions that, when executed by processing circuitry of a user equipment (UE) configured for random access in a cell of a wireless network, configure the UE to perform operations corresponding to any of the methods of embodiments E1-E4 and E11-E13.
   E17. A computer program product comprising computer-executable instructions that, when executed by processing circuitry of a user equipment (UE) configured for random access in a cell of a wireless network, configure the UE to perform operations corresponding to any of the methods of embodiments E1-E4 and E11-E13.
   E18. A network node arranged to configure random access procedures by one or more user equipment (UEs) in a cell of a wireless network, the network node comprising:
radio network interface circuitry configured to communicate with the UEs via the cell; and
processing circuitry operatively coupled to the radio network interface circuitry, whereby the processing circuitry and the radio network interface circuitry are configured to perform operations corresponding to any of the methods of embodiments E1-E10.
   E19. A network node arranged to configure random access procedures by one or more user equipment (UEs) in a cell of a wireless network, the network node being further arranged to perform operations corresponding to any of the methods of embodiments E1-E10.
   E20. A non-transitory, computer-readable medium storing computer-executable instructions that, when executed by processing circuitry of a network node arranged to configure random access procedures by one or more user equipment (UEs) in a cell of a wireless network, configure the network node to perform operations corresponding to any of the methods of embodiments E1-E10.
   E21. A computer program product comprising computer-executable instructions that, when executed by processing circuitry of a network node arranged to configure random access procedures by one or more user equipment (UEs) in a cell of a wireless network, configure the network node to perform operations corresponding to any of the methods of embodiments E1-E10.

1.-37. (canceled)

38. A method for a network node to manage random access by one or more user equipment (UEs) to a cell of a wireless network, the method comprising:
providing one of the following to one or more UEs operating in the cell:
an artificial intelligence/machine learning (AI/ML) predictive model that includes one or more input parameters and corresponding one or more output parameters that are associated with random-access configurations for the cell; or
one or more random-access configurations for the cell, with each random-access configuration being associated with one or more values of output parameters of the AI/ML predictive model; and
detecting a random access to the cell by a particular UE, wherein the random access is according to a particular random-access configuration associated with particular values of the output parameters.

39. The method of claim 38, further comprising collecting a training dataset with a plurality of training dataset entries, wherein each training dataset entry includes input parameter values and corresponding output parameter values.

40. The method of claim 39, wherein the training dataset includes one or more of the following:
measurements of downlink (DL) signals made by UEs operating in the cell;
measurements of uplink (UL) signals transmitted by UEs operating in the cell;
measurements from one or more network nodes serving neighbor cells;
random access reports by UEs operating in the cell;
connection establishment failure reports by UEs operating in the cell;
location information for UEs operating in the cell; and
timing advance for UEs operating in the cell.

41. The method of claim 39, wherein each training dataset entry includes:
one or more of the following input parameter values:
one or more measurements made by a UE on neighboring cells or frequencies, and
one or more beam measurements made by a UE in the cell; and
one or more of the following corresponding output parameter values:
an indication of failed or successful random access to the cell, and
an indication of failed or successful connection establishment.

42. The method of claim 39, wherein:
the provided AI/ML predictive model is untrained; and
the method further comprises sending at least a first portion of the training dataset to the one or more UEs.

43. The method of claim 39, further comprising training the AI/ML predictive model based on at least a first portion of the training dataset.

44. The method of claim 43, wherein the trained AI/ML predictive model is provided to the one or more UEs.

45. The method of claim 42, further comprising:
receiving one or more of the following from a particular UE operating in the cell:
an indication that the provided AI/ML predictive model needs to be retrained, and
a request for a further training dataset for retraining the model; and
performing one of the following:
sending a second portion of the training dataset to the particular UE, or
retraining the AI/ML predictive model based a second portion of the training dataset and sending the retrained AI/ML predictive model to the particular UE.

46. The method of claim 43, further comprising obtaining the one or more random-access configurations for the cell based on the trained AI/ML predictive model, wherein the obtained random-access configurations are provided to the one or more UEs via broadcast in the cell.

47. The method of claim 38, further comprising selecting the AI/ML predictive model from a plurality of available model types based on one or more of the following criteria: wireless network capabilities, UE capabilities, model size and/or complexity, severity of random access problems in the cell, available inputs, necessary and/or desirable outputs, need for retraining the model.

48. The method of claim 38, wherein the input parameters to the AI/ML predictive model include any of the following:
cell- and beam-level link quality of the cell;
cell- and beam-level link quality of the one or more neighbor cells;
relations between beams of the cell and the neighbor cells;
UE timing advance;
UE location;
UE precoding matrix indicator, PMI;
strength or quality of uplink (UL) reference signals received from UEs;
random access collisions reported by UEs; and
one or more of the following UE-related information: model, class, type, manufacturer, receiver type, and number of antennas.

49. The method of claim 38, wherein the output parameters of the AI/ML predictive model include any of the following:
one or more power levels for an initial transmission of a random-access preamble,
one or more measurement thresholds corresponding to the power levels,
one or more power ramping steps for retransmissions of the random-access preamble,
maximum number of preamble retransmissions before declaring random access failure, and
set of downlink (DL) beams to be used for random access.

50. The method of claim 38, wherein the AI/ML predictive model includes, for each beam of one of more downlink (DL) beams of the cell, one or more relations between a measurement range of a reference signal of the beam and a corresponding power level for an initial transmission of a random-access preamble.

51. A network node arranged to manage random access by one or more user equipment (UEs) to a cell of a wireless network, the network node comprising:
radio network interface circuitry configured to communicate with the UEs via the cell; and
processing circuitry operatively coupled to the radio network interface circuitry, whereby the processing circuitry and the radio network interface circuitry are configured to:
provide one of the following to one or more UEs operating in the cell:
an artificial intelligence/machine learning (AI/ML) predictive model that includes one or more input parameters and corresponding one or more output parameters that are associated with random-access configurations for the cell, or
one or more random-access configurations for the cell, with each random-access configuration being associated with one or more values of output parameters of the AI/ML predictive model; and
detect a random access to the cell by a particular UE, wherein the random access is according to a particular random-access configuration associated with particular values of the output parameters.

52. The network node of claim 51, wherein the processing circuitry and the radio network interface circuitry are further configured to collect a training dataset with a plurality of training dataset entries, wherein each training dataset entry includes input parameter values and corresponding output parameter values.

53. The network node of claim 52, wherein the training dataset includes one or more of the following:
measurements of downlink (DL) signals made by UEs operating in the cell;
measurements of uplink (UL) signals transmitted by UEs operating in the cell;
measurements from one or more network nodes serving neighbor cells;
random access reports by UEs operating in the cell;
connection establishment failure reports by UEs operating in the cell;
location information for UEs operating in the cell; and
timing advance for UEs operating in the cell.

54. The network node of claim 52, wherein each training dataset entry includes:
one or more of the following input parameter values:
one or more measurements made by a UE on neighboring cells or frequencies, and
one or more beam measurements made by a UE in the cell; and
one or more of the following corresponding output parameter values:
an indication of failed or successful random access to the cell, and
an indication of failed or successful connection establishment.

55. The network node of claim 52, wherein:
the provided AI/ML predictive model is untrained; and
the method further comprises sending at least a first portion of the training dataset to the one or more UEs.

56. The network node of claim 55, wherein the processing circuitry and the radio network interface circuitry are further configured to:
receive one or more of the following from a particular UE operating in the cell:
an indication that the provided AI/ML predictive model needs to be retrained, and
a request for a further training dataset for retraining the model; and
perform one of the following:
send a second portion of the training dataset to the particular UE, or
retrain the AI/ML predictive model based a second portion of the training dataset and sending the retrained AI/ML predictive model to the particular UE.

57. A non-transitory, computer-readable medium storing computer-executable instructions that, when executed by processing circuitry of a network node arranged to manage random access by one or more user equipment (UEs) to a cell of a wireless network, configure the network node to perform operations corresponding to the method of claim 38.
